(19) United States
(12) Patent Application Publication
(10) Pub. No.: US 2026/0340035 A1
(43) Pub. Date: Oct. 29, 2026

(54) INFORMATION PROCESSING SYSTEM AND INFORMATION PROCESSING METHOD

(71) Applicant: Semiconductor Energy Laboratory Co., Ltd., Atsugi-shi (JP)

(72) Inventors: Junpei MOMO, Sagamihara (JP); Tatsuya OKANO, Isehara (JP)

(21) Appl. No.: 19/648,404

(22) Filed: Apr. 15, 2026

(30) Foreign Application Priority Data
Apr. 24, 2025 (JP) 2025-072117

(51) Int. Cl. G06F 16/901; G06F 16/9032

(52) U.S. Cl. CPC G06F 16/9024; G06F 16/90332

(57) ABSTRACT

A processing system including a first component, a second component, and a third component is provided. The first component receives and transmits a material to the third component, and receives a first graph which is provided to the user. The second component receives a prompt, and generates an interpretation sentence and the first graph with the use of a vision language model. The third component has a function of receiving the material and transmitting the prompt to the second component, and a function of receiving the interpretation sentence and the first graph. The third component has a function of creating and executing a prompt chain and includes a management system and a graph database. Accordingly, the interpretation sentence and the first graph can be generated from the material, and a natural language description and a graph described in a graph description language can be provided.

### BACKGROUND OF THE INVENTION

### 1. Field of the Invention

One embodiment of the present invention relates to an information processing system, an information processing method, or a semiconductor device.

Note that one embodiment of the present invention is not limited to the above technical field. The technical field of one embodiment of the invention disclosed in this specification and the like relates to an object, a method, or a manufacturing method. In addition, one embodiment of the present invention relates to a process, a machine, manufacture, or a composition of matter. Thus, more specifically, examples of the technical field of one embodiment of the present invention disclosed in this specification include an information processing device, a semiconductor device, a memory device, a driving method thereof, and a manufacturing method thereof.

### 2. Description of the Related Art

In recent years, language models using neural networks have been actively developed, and especially large language models (LLM) have attracted attention. A large language model is a natural language processing model learned with the use of a large amount of data. With a large language model, for example, a communication model that gives an answer to a user's instruction can be achieved. In Non-Patent Document 1, Generative Pre-trained Transformer 4 (GPT-4, registered trademark) is disclosed as a large language model, and ChatGPT is disclosed as an interactive model.

By utilizing a large language model, the capability of a natural language processing model has been significantly increased. On the other hand, due to the expansion of the language model, it is difficult to incorporate and operate a language model on one's own from the aspect of facilities and costs. Accordingly, utilizing an external service that provides a language model is one of the utility forms of a language model.

A document search system that searches for a document with the concept of the document taken into account is known. For example, a document search system including an input unit, a first processing unit, a memory unit, a second processing unit, and an output unit is disclosed (Patent Document 1). The input unit has a function of inputting a first document, the first processing unit has a function of creating a first graph structure from the first document, the memory unit has a function of storing a second graph structure, the second processing unit has a function of calculating the similarity between the first graph structure and the second graph structure, the output unit has a function of supplying information, the first processing unit has a function of dividing the first document into a plurality of tokens, a node and an edge of the first graph structure include a label, and the label includes the plurality of tokens.

### References

### Non-Patent Document

Summary of ChatGPT/GPT-4 Research and Perspective Towards the Future of Large Language Models, Yiheng Liu et al., (submitted on 4 Apr., 2023) [online], Internet URL: https://arxiv.org/abs/2304.01852

WO2021/079230

### SUMMARY OF THE INVENTION

One object of one embodiment of the present invention is to provide a novel information processing system that is highly convenient, useful, or reliable. Another object of one embodiment of the present invention is to provide a novel information processing method that is highly convenient, useful, or reliable. Another object of one embodiment of the present invention is to provide a novel information processing system, a novel information processing method, or a novel semiconductor device.

Note that the description of these objects does not preclude the existence of other objects. One embodiment of the present invention does not need to achieve all these objects. Other objects will be apparent from and can be derived from the description of the specification, the drawings, the claims, and the like.

1. One embodiment of the present invention is an information processing system configured to receive a material and provide a first graph.

Note that the material includes a first document and a first diagram. The first document includes a first element and a second element. The first diagram is a diagram illustrating the first component, the second component, and a relation between the first element and the second element.

The first graph includes a first node, a second node, and an edge. The first node is configured to store information relating to the first element. The second node is configured to store information relating to the second element. The edge is configured to store information relating to the relation between the first element and the second element.

2. Another embodiment of the present invention is an information processing system including a first component, a second component, and a third component.

The first component is configured to receive a material and transmit the material to the third component and is configured to receive and provide a first graph. The material includes a first document and a first diagram. The first document includes a first element and a second element. The first diagram is a diagram illustrating the first element, the second element, and a relation between the first element and the second element. The first graph includes a first node, a second node, and an edge. The first node is configured to store information relating to the first element. The second node is configured to store information relating to the second element. The edge is configured to store information relating to the relation between the first element and the second element.

The second component is configured to receive a first prompt and transmit an interpretation sentence to the third component, is configured to receive a second prompt and transmit the first graph to the third component, and is configured to perform processing using a vision language model. The vision language model is configured to generate the interpretation sentence in accordance with the first prompt and is configured to generate the first graph in accordance with the second prompt.

The third component is configured to receive the material, the interpretation sentence, and the first graph and sharing the material, the interpretation sentence, and the first graph inside the third component, is configured to transmit the first prompt and the second prompt to the second component, and is configured to transmit the first graph to the first component. The third component includes a first subcomponent and a second subcomponent.

The first subcomponent is configured to create and execute a first prompt chain and is configured to create a first query sentence.

The first prompt chain includes the first prompt and the second prompt. The first prompt includes a first instruction, the first document, and the first diagram. The first instruction includes a procedure for generating the interpretation sentence from the first diagram in consideration of the first document. Note that the interpretation sentence includes a natural language description of the first element, the second element, and the relation between the first element and the second element. The second prompt includes a second instruction, the first document, and the interpretation sentence. The second instruction includes a procedure for generating the first graph from the first document and the interpretation sentence. Note that the first graph is described in a graph description language. The first query sentence includes a request to register the first graph.

The second subcomponent includes a management system and a graph database. The management system is configured to register the first graph in the graph database in accordance with the first query sentence.

Accordingly, an interpretation sentence relating to the first diagram can be generated from the material. For example, a relation between the first element and the second element that is not included in the first document can be read from the first diagram. The first element, the second element, and the relation between the first element and the second element can be read from the material. The first element, the second element, and the relation between the first element and the second element can be described in a natural language in the first document and the interpretation sentence. The first element, the second element, and the relation between the first element and the second element can be described in a graph description language in the first graph. The first graph described in a graph description language can be provided and registered in the graph database. An expression using a natural language of the user of the information processing system, for example, can be complemented with information taken from an expression using the first diagram. Additionally, for example, with the use of the first graph, the information processing system can share a framework of the information with the user of the information processing system. Furthermore, for example, a material modified by the user of the information processing system can be input and the first graph modified by the information processing system can be provided. Moreover, by repeating the above, the description can be improved. As a result, a novel information processing system that is highly convenient, useful, or reliable can be provided.

3. Another aspect of one embodiment of the present invention is the above information processing system in which the first component is configured to receive and provide the interpretation sentence and the third component is configured to transmit the interpretation sentence to the first component.

Accordingly, an interpretation sentence relating to the first diagram can be generated from the material. An interpretation sentence described in a natural language can be provided. As a result, a novel information processing system that is highly convenient, useful, or reliable can be provided.

4. Another aspect of one embodiment of the present invention is the above information processing system in which the first component is configured to receive and provide a second diagram and an evaluation result. Note that the second diagram is a diagram illustrating the first element, the second element, and the relation between the first element and the second element. The evaluation result includes a result of an evaluation of the second diagram based on the first diagram.

The second component is configured to receive a third prompt and transmit the second diagram to the third component and is configured to receive a fourth prompt and transmit the evaluation result to the third component. The vision language model is configured to generate the second diagram in accordance with the third prompt and is configured to generate the evaluation result in accordance with the fourth prompt.

The third component is configured to transmit the third prompt and the fourth prompt to the second component, is configured to receive the second diagram and the evaluation result and share the second diagram and the evaluation result inside the third component, and is configured to transmit the evaluation result to the first component.

The first subcomponent is configured to create and execute a second prompt chain. The second prompt chain includes the third prompt and the fourth prompt. The third prompt includes a third instruction and the first graph. The third instruction includes a procedure for generating the second diagram from the first graph. The fourth prompt includes a fourth instruction, the first diagram, and the second diagram. The fourth instruction includes a procedure for evaluating the second diagram on the basis of the first diagram.

Accordingly, the second diagram can be generated from the first graph described in the graph description language. The first element, the second element, and a relation between the first element and the second element described in the first graph can be expressed in the second diagram. The first element, the second element, and a relation between the first element and the second element expressed in the second diagram can be evaluated on the basis of the first diagram. For example, with the use of the second diagram, the information processing system can share a framework of the information with the user of the information processing system. Furthermore, for example, a material modified by the user of the information processing system, can be input and the second diagram modified by the information processing system can be provided. Moreover, by repeating the above, the description can be improved. As a result, a novel information processing system that is highly convenient, useful, or reliable can be provided.

5. Another aspect of one embodiment of the present invention is the above information processing system in which the first component is configured to receive an idea document and transmit the idea document to the third component and is configured to receive and provide a second graph.

Note that the idea document includes a third element. The second graph includes a third node. The third node is configured to store information relating to the third element.

The second component is configured to receive a fifth prompt and transmit the second graph to the third component, and is configured to perform processing using a large language model. The large language model is configured to generate the second graph in accordance with the fifth prompt.

The third component is configured to receive the idea document and the second graph and to share the idea document and the second graph inside the third component, is configured to transmit the fifth prompt to the second component, and is configured to transmit the second graph to the first component.

The first subcomponent is configured to create the fifth prompt and is configured to create a second query sentence.

The fifth prompt includes a fifth instruction and the idea document. The fifth instruction includes a procedure for generating the second graph from the idea document. The second graph is described in the graph description language. The second query sentence includes a request to register the second graph.

The management system is configured to register the second graph in the graph database in accordance with the second query sentence.

Accordingly, information relating to the third element described in the idea document can be stored in the third node of the second graph. The second graph can be generated from the idea document. Additionally, for example, the user of the information processing system can be provided with the second graph. The second graph can be registered in the graph database. As a result, a novel information processing system that is highly convenient, useful, or reliable can be provided.

6. Another aspect of one embodiment of the present invention is the above information processing system in which the first component is configured to receive a selection command and transmit specifying information to the third component, and is configured to receive and provide a question. Note that the specifying information includes information specifying the third node of the second graph, and the question includes a question relating to the third element.

The second component is configured to receive a sixth prompt and transmit the question to the third component, and the large language model is configured to generate the question in accordance with the sixth prompt.

The third component is configured to receive the specifying information and transmit the sixth prompt to the second component, and is configured to receive the question and transmit the question to the first component.

The first subcomponent is configured to create a third query sentence and the sixth prompt. The third query sentence includes a request to obtain information relating to the third element stored in the third node on the basis of the specifying information. The sixth prompt includes a sixth instruction and the information. The sixth instruction includes a procedure for generating the question regarding the information. The management system is configured to obtain the information from the graph database in accordance with the third query sentence.

Accordingly, information relating to the third element can be obtained from the second graph on the basis of the specifying information. In addition, a question regarding the information on the third element can be generated. As a result, a novel information processing system that is highly convenient, useful, or reliable can be provided.

7. Another aspect of one embodiment of the present invention is the above information processing system in which the first component is configured to receive a selection command and transmit specifying information to the third component, and is configured to receive and provide a question. Note that the second graph includes a fourth node and a second edge, the fourth node is configured to store information relating to a fourth element, and the second edge is configured to store information relating to a relation between the third element and the fourth element. The specifying information includes information specifying the second edge of the second graph. The question includes a question relating to the relation between the third element and the fourth element.

The second component is configured to receive a sixth prompt and transmit the question to the third component. The large language model is configured to generate the question in accordance with the sixth prompt,

The third component is configured to receive the specifying information and transmit the sixth prompt to the second component, and is configured to receive the question and transmit the question to the first component.

The first subcomponent is configured to create a third query sentence and the sixth prompt. The third query sentence includes a request to obtain, on the basis of the specifying information, information relating to the relation between the third element and the fourth element stored in the second edge. The sixth prompt includes a sixth instruction and the information. The sixth instruction includes a procedure for generating a question regarding the information. The management system is configured to obtain the information from the graph database in accordance with the third query sentence.

Accordingly, information relating to the relation between the third element and the fourth element can be obtained from the second graph on the basis of the specifying information. Furthermore, a question regarding the information on the relation between the third element and the fourth element can be generated. As a result, a novel information processing system that is highly convenient, useful, or reliable can be provided.

8. Another aspect of one embodiment of the present invention is the above information processing system in which the first component is configured to receive a selection command and transmit a parameter to the third component, and is configured to receive and provide a second document. Note that the parameter includes information for starting generation of the second document, and the second document includes a description relating to the first element, the second element, and the relation between the first element and the second element.

The second component is configured to receive a third prompt and transmit the second document to the third component, and is configured to perform processing using a large language model. The large language model is configured to generate the second document in accordance with the third prompt.

The third component is configured to receive the parameter and transmit the third prompt to the second component, and is configured to receive the second document and transmit the second document to the first component.

The first subcomponent is configured to create a second query sentence and the third prompt. The second query sentence includes a request to obtain the first graph from the graph database. The third prompt includes a third instruction and the first graph. The third instruction includes a procedure for generating the second document from the first graph.

Accordingly, the second document including a description relating to the first element, the second element, and the relation between the first element and the second element can be generated from the material. As a result, a novel information processing system that is highly convenient, useful, or reliable can be provided.

9. Another aspect of one embodiment of the present invention is an information processing method including a first phase. The first phase includes a first step, a second step, a third step, a fourth step, a fifth step, a sixth step, a seventh step, an eighth step, a ninth step, a tenth step, an eleventh step, a twelfth step, and a thirteenth step.

In the first step of the first phase, a first component receives a material and transmits the material to a second component. The material includes a first document and a first diagram. The first document includes a first element and a second element. The first diagram is a diagram illustrating the first element, the second element, and a relation between the first element and the second element.

In the second step of the first phase, the second component receives the material and shares the material inside the second component. The second component includes a first subcomponent and a second subcomponent. The first subcomponent is configured to create and execute a first prompt chain and is configured to create a query sentence. The first prompt chain includes a first prompt and a second prompt. The second subcomponent includes a graph database and a management system.

In the third step of the first phase, the first subcomponent creates the first prompt and transmits the first prompt to a third component. The first prompt includes a first instruction, the first document, and the first diagram. The first instruction includes a procedure for generating an interpretation sentence from the first diagram in consideration of the first document. The interpretation sentence includes a natural language description of the first component, the second component, and the relation between the first element and the second element.

In the fourth step of the first phase, the third component receives the first prompt, generates the interpretation sentence with the use of a vision language model, and transmits the interpretation sentence to the second component.

In the fifth step of the first phase, the second component receives the interpretation sentence and shares the interpretation sentence inside the second component.

In the sixth step of the first phase, the first subcomponent creates the second prompt and transmits the second prompt to the third component. Note that the second prompt includes a second instruction, the first document, and the interpretation sentence, and the second instruction includes a procedure for generating a first graph from the first document and the interpretation sentence. The first graph is described in a graph description language.

In the seventh step of the first phase, the third component receives the second prompt, generates the first graph with the use of the vision language model, and transmits the first graph to the second component.

In the eighth step of the first phase, the second component receives the first graph and shares the first graph inside the second component.

In the ninth step of the first phase, the first subcomponent creates the query sentence. Note that the query sentence includes a request to register the first graph.

In the tenth step of the first phase, the second subcomponent creates and shares the query sentence inside the second component.

In the eleventh step of the first phase, the management system registers the first graph in the graph database in accordance with the query sentence.

In the twelfth step of the first phase, the second component transmits the first graph to the first component.

In the thirteenth step of the first phase, the first component receives and provides the first graph.

Accordingly, an interpretation sentence relating to the first diagram can be generated from the material. For example, a relation between the first element and the second element that is not included in the first document can be read from the first diagram. The first element, the second element, and the relation between the first element and the second element can be read from the material. The first element, the second element, and the relation between the first element and the second element can be described in a natural language in the first document and the interpretation sentence. The first element, the second element, and the relation between the first element and the second element can be described in a graph description language in the first graph. The first graph described in a graph description language can be provided and registered in the graph database. An expression using a natural language of the user of the information processing system, for example, can be complemented with information taken from an expression using the first diagram. Additionally, for example, with the use of the first graph, the information processing system can share a framework of the information with the user of the information processing system. Furthermore, for example, a material modified by the user of the information processing system can be input and the first graph modified by the information processing system can be provided. Moreover, by repeating the above, the description can be improved. As a result, a novel information processing method that is highly convenient, useful, or reliable can be provided.

10. Another aspect of one embodiment of the present invention is the above information processing method in which in the twelfth step of the first phase, the second component transmits the first graph and the interpretation sentence to the first component.

In the thirteenth step of the first phase, the first component receives and provides the first graph and the interpretation sentence.

Accordingly, an interpretation sentence relating to the first diagram can be generated from the material. An interpretation sentence described in a natural language can be provided. As a result, a novel information processing method that is highly convenient, useful, or reliable can be provided.

11. Another aspect of one embodiment of the present invention is the above information processing method further including a fourteenth step, a fifteenth step, a sixteenth step, a seventeenth step, an eighteenth step, a nineteenth step, a twentieth step, and a twenty-first step in the first phase.

The fourteenth step of the first phase follows the thirteenth step of the first phase. The first subcomponent is configured to create and execute a second prompt chain. The second prompt chain includes a third prompt and a fourth prompt.

In the fourteenth step of the first phase, the first subcomponent creates the third prompt and transmits the third prompt to the third component. The third prompt includes a third instruction and the first graph. The third instruction includes a procedure for generating a second diagram from the first graph.

In the fifteenth step of the first phase, the third component receives the third prompt, generates the second diagram with use of the vision language model, and transmits the second diagram to the second component.

In the sixteenth step of the first phase, the second component receives the second diagram and shares the second diagram inside the second component.

In the seventeenth step of the first phase, the first subcomponent creates the fourth prompt and transmits the fourth prompt to the third component. Note that the fourth prompt includes a fourth instruction, the first diagram, and the second diagram, and the fourth instruction includes a procedure for evaluating the second diagram based on the first diagram.

In the eighteenth step of the first phase, the third component receives the fourth prompt, generates an evaluation result in accordance with the fourth prompt with the use of the vision language model, and transmits the evaluation result to the second component.

In the nineteenth step of the first phase, the second component receives the evaluation result and shares the evaluation result inside the second component.

In the twentieth step of the first phase, the second component transmits the second diagram and the evaluation result to the first component.

In the twenty-first step of the first phase, the first component receives and provides the second diagram and the evaluation result.

Accordingly, the second diagram can be generated from the first graph described in a graph description language. Moreover, the first element, the second element, and the relation between the first element and the second element that are described in the first graph can be expressed in the second diagram. In addition, the first element, the second element, and the relation between the first element and the second element that are expressed in the second diagram can be evaluated on the basis of the first diagram. For example, with the use of the second diagram, the information processing system can share a framework of the information with the user of the information processing system. Furthermore, for example, a material modified by the user of the information processing system can be input and the second diagram modified by the information processing system can be provided. Moreover, by repeating the above, the description can be improved. As a result, a novel information processing method that is highly convenient, useful, or reliable can be provided.

12. Another aspect of one embodiment of the present invention is the above information processing method further including a second phase. The first phase follows the second phase. The second phase includes a first step, a second step, a third step, a fourth step, a fifth step, a sixth step, and a seventh step.

In the first step of the second phase, the first component receives an idea document and transmits the idea document to the second component.

In the second step of the second phase, the second component receives the idea document and shares the idea document inside the second component. Note that the first subcomponent is configured to create a fifth prompt and is configured to create a fourth query sentence.

In the third step of the second phase, the first subcomponent creates the fifth prompt and transmits the fifth prompt to the third component. The fifth prompt includes a fifth instruction and the idea document. The fifth instruction includes a procedure for generating a second graph from the idea document. The second graph is described in the graph description language.

In the fourth step of the second phase, the third component receives the fifth prompt, generates the graph with use of a large language model, and transmits the second graph to the second component

In the fifth step of the second phase, the second component receives the second graph and shares the second graph inside the second component.

In the sixth step of the second phase, the first subcomponent creates the second query sentence and shares the second query sentence inside the second component. Note the second query sentence includes a request to register the second graph.

In the seventh step of the second phase, the management system registers the second graph in the graph database in accordance with the second query sentence.

Accordingly, information relating to the third element described in the idea document can be stored in a node of the second graph. The second graph can be generated from the idea document. Additionally, for example, the second graph can be provided to the user of the information processing method. The second graph can be registered in the graph database. As a result, a novel information processing method that is highly convenient, useful, or reliable can be provided.

13. Another aspect of one embodiment of the present invention is the above information processing method further including an eighth step, a ninth step, a tenth step, an eleventh step, a twelfth step, a thirteenth step, a fourteenth step, and a fifteenth step in the second phase. The eighth step of the second phase follows the seventh step of the second phase.

In the eighth step of the second phase, the first component receives a selection command and transmits specifying information to the second component. Note the specifying information includes information specifying a node of the second graph.

In the ninth step of the second phase, the second component receives the specifying information and shares the specifying information inside the second component.

In the tenth step of the second phase, the first subcomponent creates a third query sentence and shares the third query sentence inside the second component. Note that the third query sentence includes a request to obtain information relating to a third element stored in the node on the basis of the specifying information.

In the eleventh step of the second phase, the management system obtains the information from the graph database in accordance with the third query sentence, and shares the information inside the second component.

In the twelfth step of the second phase, the first subcomponent creates a sixth prompt and transmits the sixth prompt to the third component. Note that the sixth prompt includes a sixth instruction, and the information and the sixth instruction includes a procedure for generating a question regarding the information.

In the thirteenth step of the second phase, the third component receives the sixth prompt, generates the question with the use of the large language model, and transmits the question to the second component.

In the fourteenth step of the second phase, the second component receives the question and transmits the question to the first component.

In the fifteenth step of the second phase, the first component receives and provides the question.

Accordingly, information relating to the third element can be obtained from the second graph on the basis of the specifying information. In addition, a question regarding the information on the third element can be generated. As a result, a novel information processing method that is highly convenient, useful, or reliable can be provided.

14. Another aspect of one embodiment of the present invention is the above information processing method further including an eighth step, ninth step, tenth step, eleventh step, twelfth step, thirteenth step, fourteenth step, and fifteenth step in the second phase. The eighth step of the second phase follows the seventh step of the second phase.

In the eighth step of the second phase, the first component receives a selection command and transmits specifying information to the second component. Note that the specifying information includes information specifying an edge of the second graph.

In the ninth step of the second phase, the second component receives the specifying information and shares the specifying information inside the second component.

In the tenth step of the second phase, the first subcomponent creates a third query sentence and shares the third query sentence inside the second component. Note that the third query sentence includes a request to obtain information relating to a relation between a third element and a fourth element stored in the edge on the basis of the specifying information.

In the eleventh step of the second phase, the management system obtains the information from the graph database in accordance with the third query sentence, and shares the information inside the second component.

In the twelfth step of the second phase, the first subcomponent creates a sixth prompt and transmits the sixth prompt to the third component. Note that the sixth prompt includes a sixth instruction and the information, and the sixth instruction includes a procedure for generating a question regarding the information.

In the thirteenth step of the second phase, the third component receives the sixth prompt, generates the question with the use of the large language model, and transmits the question to the second component.

In the fourteenth step of the second phase, the second component receives the question and transmits the question to the first component.

In the fifteenth step of the second phase, the first component receives and provides the question.

Accordingly, information relating to the relation between the third element and the fourth element can be obtained from the second graph on the basis of the specifying information. Furthermore, a question regarding the information on the relation between the third element and the fourth element can be generated. As a result, a novel information processing method that is highly convenient, useful, or reliable can be provided.

15. Another aspect of one embodiment of the present invention is the above information processing method further including a third phase. The third phase follows the first phase. The third phase includes a first step, a second step, a third step, a fourth step, a fifth step, a sixth step, a seventh step, and an eighth step.

In the first step of the third phase, the first component receives a selection command and transmits a parameter to the second component. Note that the parameter includes information for starting generation of a second document. The second document includes a description relating to the first element, the second element, and a relation between the first element and the second element.

In the second step of the third phase, the second component receives the parameter and shares the parameter inside the second component.

In the third step of the third phase, the first subcomponent creates a fourth query sentence and shares the fourth query sentence inside the second component. The fourth query sentence includes a request to obtain the first graph from the graph database.

In the fourth step of the third phase, the management system obtains the first graph from the graph database in accordance with the fourth query sentence and shares the first graph inside the second component.

In the fifth step of the third phase, the first subcomponent creates a seventh prompt and transmits the seventh prompt to the third component. Note that the seventh prompt includes a seventh instruction and the first graph and the seventh instruction includes a procedure for generating the second document from the first graph.

In the sixth step of the third phase, the third component receives the seventh prompt, generates the second document with the use of a large language model, and transmits the second document to the second component.

In the seventh step of the third phase, the second component receives the second document and transmits the second document to the first component.

In the eighth step of the third phase, the first component receives and provides the second document.

Accordingly, the second document including a description relating to the first element, the second element, and the relation between the first element and the second element can be generated from the material. As a result, a novel information processing method that is highly convenient, useful, or reliable can be provided.

One embodiment of the present invention can provide a novel information processing system that is highly convenient, useful, or reliable. Another embodiment of the present invention can provide a novel information processing method that is highly convenient, useful, or reliable. Another embodiment of the present invention can provide a novel information processing system, a novel information processing method, or a novel semiconductor device.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

FIG. 1 illustrates a structure of an information processing system of an embodiment.

FIGS. 2A - 2C illustrate structures of a component, a material, and a diagram, respectively, used in an information processing system of an embodiment.

FIGS. 3A and 3B illustrate structures of a document and a diagram, respectively, used in an information processing system of an embodiment.

FIGS. 4A - 4C each illustrate a structure of a node or an edge of a graph used in an information processing system of an embodiment.

FIG. 5 illustrates a structure of a component used in an information processing system of an embodiment.

FIGS. 6A - 6C each illustrate a structure of a prompt used in an information processing system of an embodiment.

FIGS. 7A and 7B illustrate structures of a component and a diagram, respectively, used in an information processing system of an embodiment.

FIGS. 8A - 8C each illustrate a structure of a prompt used in an information processing system of an embodiment.

FIG. 9 illustrates a structure of an information processing system of an embodiment.

FIGS. 10A - 10C illustrate structures of a component, a material, or a graph, respectively, used in an information processing system of an embodiment.

FIG. 11 illustrates a structure of a component used in an information processing system of an embodiment.

FIGS. 12A -12C each illustrate a structure of a prompt used in an information processing system of an embodiment.

FIGS. 13A and 13B each illustrate a structure of a node or an edge of a graph used in an information processing system of an embodiment.

FIG. 14 illustrates a structure of an information processing system of an embodiment.

FIG. 15 illustrates a structure of a component used in an information processing system of an embodiment.

FIG. 16 illustrates a structure of a prompt used in an information processing system of an embodiment.

FIG. 17 illustrates a structure of an information processing device used for an information processing system of an embodiment.

FIG. 18 shows an information processing method of an embodiment.

FIG. 19 shows an information processing method of an embodiment.

FIG. 20 shows an information processing method of an embodiment.

FIG. 21 shows an information processing method of an embodiment.

### DETAILED DESCRIPTION OF THE INVENTION

One embodiment of the present invention is an information processing system including a first component, a second component, and a third component.

The first component has a function of receiving a material and transmitting the material to the third component and a function of receiving and providing a first graph. Note that the material includes a first document and a first diagram, and the first document includes the first element and the second element. The first diagram is a diagram illustrating the first element, the second element, and a relation between the first element and the second element. The first graph includes a first node, a second node, and an edge. The first node has a function of storing information relating to the first element. The second node has a function of storing information relating to the second element. The edge has a function of storing information relating to the relation between the first element and the second element.

The second component has a function of receiving a first prompt and transmitting an interpretation sentence to the third component, a function of receiving a second prompt and transmitting the first graph to the third component, and a function of performing processing using a vision language model. The vision language model has a function of generating the interpretation sentence in accordance with the first prompt and generating the first graph in accordance with the second prompt.

The third component has a function of receiving the material and sharing the material inside the third component, a function of transmitting the first prompt to the second component, a function of receiving the interpretation sentence and sharing the interpretation sentence inside the third component, a function of transmitting the second prompt to the second component, a function of receiving the first graph and sharing the first graph inside the third component, and a function of transmitting the first graph to the first component. The third component includes a first subcomponent and a second subcomponent.

The first subcomponent has a function of creating and executing a first prompt chain and a function of creating a first query sentence, and the first prompt chain includes the first prompt and the second prompt. The first prompt includes a first instruction, the first document, and the first diagram, and the first instruction includes a procedure for generating the interpretation sentence from the first diagram in consideration of the first document. The interpretation sentence includes a natural language description of the first element, the second element, and the relation between the first element and the second element. The second prompt includes a second instruction, the first document, and the interpretation sentence, and the second instruction includes a procedure for generating the first graph from the first document and the interpretation sentence. The first graph is described in a graph description language, and the first query sentence includes a request to register the first graph.

The second subcomponent includes a management system and a graph database, and the management system is configured to register the first graph in the graph database in accordance with the first query sentence.

Accordingly, the interpretation sentence relating to the first diagram can be generated from the material. For example, the relation between the first element and the second element that is not included in the first document can be read from the first diagram. The first element, the second element, and the relation between the first element and the second element can be read from the material. The first element, the second element, and the relation between the first element and the second element can be described in a natural language in the first document and the interpretation sentence. The first element, the second element, and the relation between the first element and the second element can be described in a graph description language in the first graph. The first graph described in a graph description language can be provided and registered in the graph database. An expression using a natural language of the user of the information processing system, for example, can be complemented with information taken from an expression using the first diagram. Additionally, for example, with the use of the first graph, the information processing system can share a framework of the information with the user of the information processing system. Furthermore, for example, the material modified by the user of the information processing system can be input and the first graph modified by the information processing system can be provided. Moreover, by repeating the above, the description can be improved. As a result, a novel information processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as "first" and "second" in this specification and the like are used in order to avoid confusion among elements. Thus, the terms do not limit the number of elements or the order of elements (e.g., the order of steps or the stacking order of layers). A term without an ordinal number in this specification and the like may be described with an ordinal number in a claim in order to avoid confusion among elements. A term with an ordinal number in this specification and the like may be described with a different ordinal number in the scope of claims. A term with an ordinal number in this specification and the like may be described without an ordinal number in the scope of claims.

Although a block diagram in which elements are classified by their functions and shown as independent blocks is shown in the drawing attached to this specification, it is difficult to completely separate actual elements according to their functions and one element can relate to a plurality of functions.

### Embodiment 1

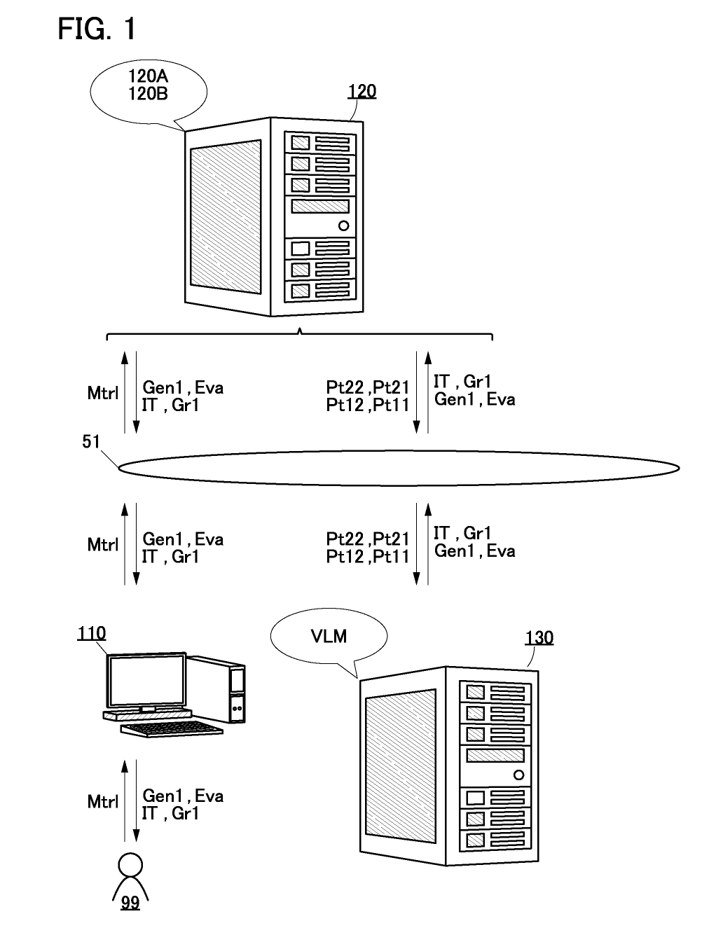

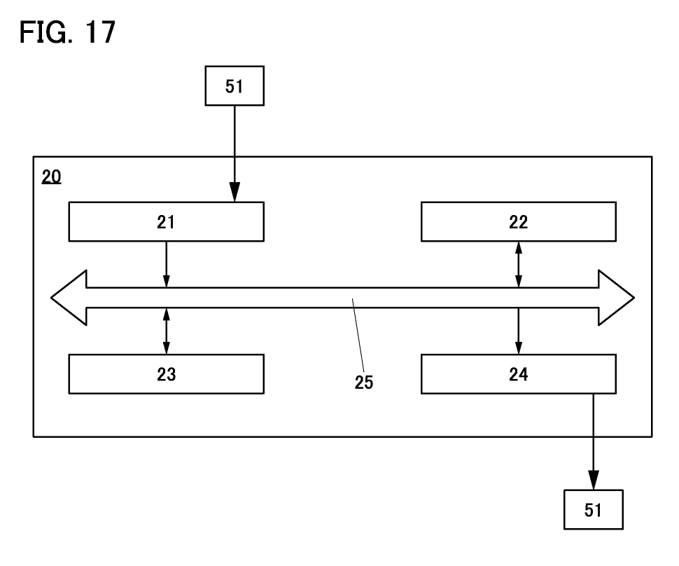

In this embodiment, an information processing system according to one embodiment of the present invention will be described with reference to FIG. 1 - FIG. 17.

FIG. 1 illustrates a structure of the information processing system according to one embodiment of the present invention.

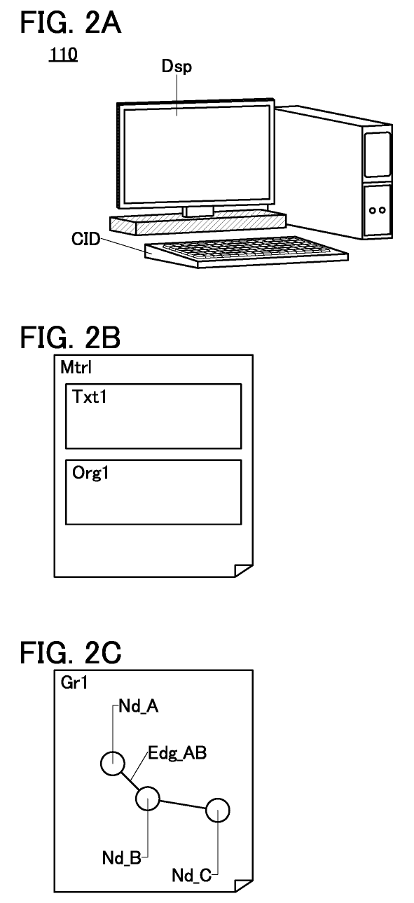

FIG. 2A is a diagram illustrating a structure of a component that can be used for the information processing system according to one embodiment of the present invention, FIG. 2B is a diagram illustrating a structure of a material received by the information processing system according to one embodiment of the present invention, and FIG. 2C is a diagram illustrating a structure of a graph provided by the information processing system according to one embodiment of the present invention.

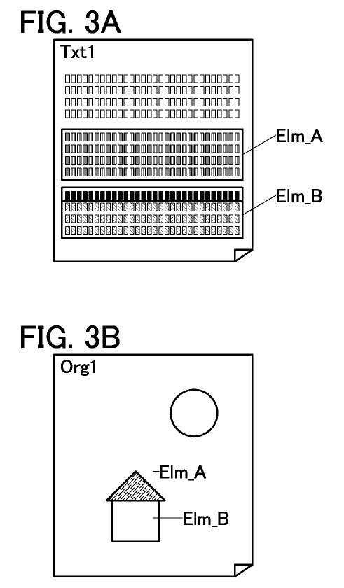

FIG. 3A is a schematic diagram illustrating a structure of a document received by the information processing system according to one embodiment of the present invention, and FIG. 3B is a schematic diagram illustrating a structure of a graph provided by the information processing system.

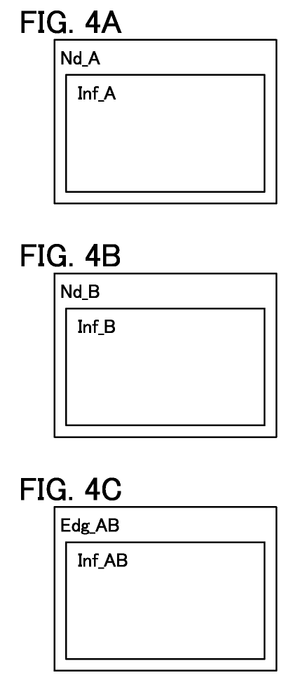

FIGS. 4A and 4B are diagrams each illustrating a structure of a node of a graph that can be used for the information processing system, and FIG. 4C is a diagram illustrating a structure of an edge.

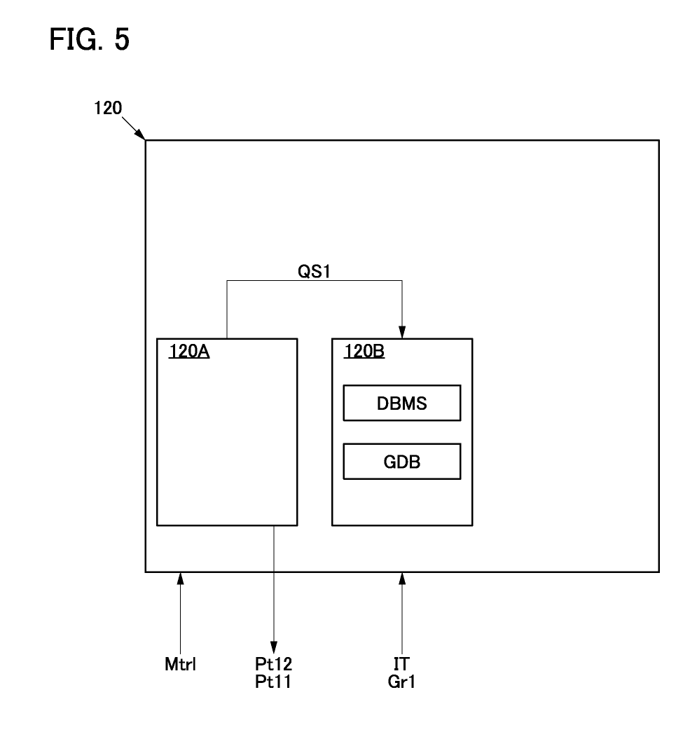

FIG. 5 is a diagram illustrating a structure of a component that can be used in the information processing system according to one embodiment of the present invention.

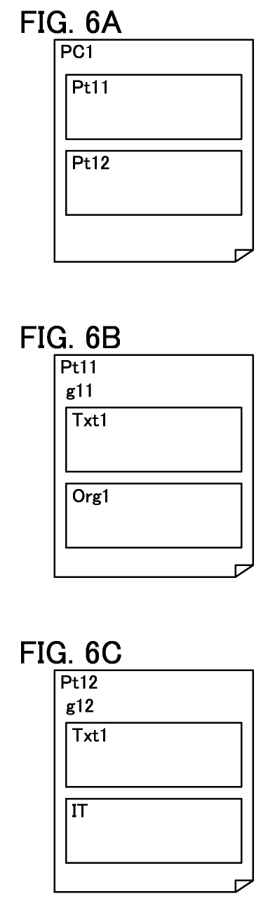

FIG. 6A is a diagram illustrating a structure of a prompt chain created inside the information processing system, and FIGS. 6B and 6C are diagrams each illustrating a structure of a prompt transmitted and received inside the information processing system.

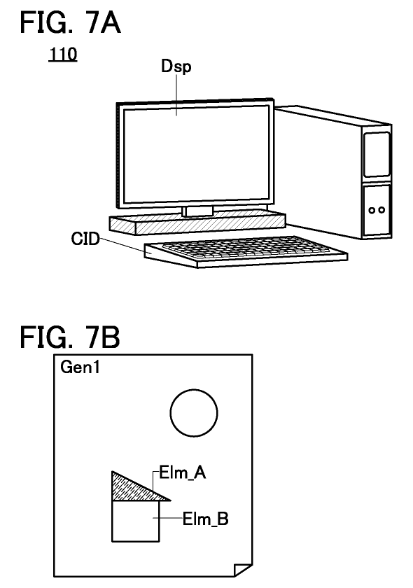

FIG. 7A is a diagram illustrating a structure of the component that can be used for the information processing system according to one embodiment of the present invention, and FIG. 7B is a diagram illustrating a structure of a diagram provided by the information processing system according to one embodiment of the present invention.

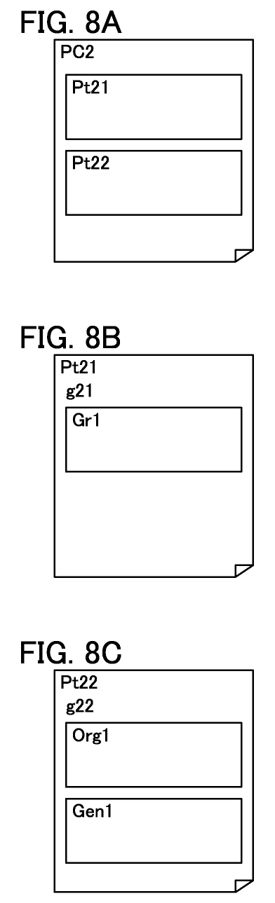

FIG. 8A is a diagram illustrating a structure of a prompt chain created inside the information processing system, and FIGS. 8B and 8C are diagrams each illustrating a structure of a prompt transmitted and received inside the information processing system.

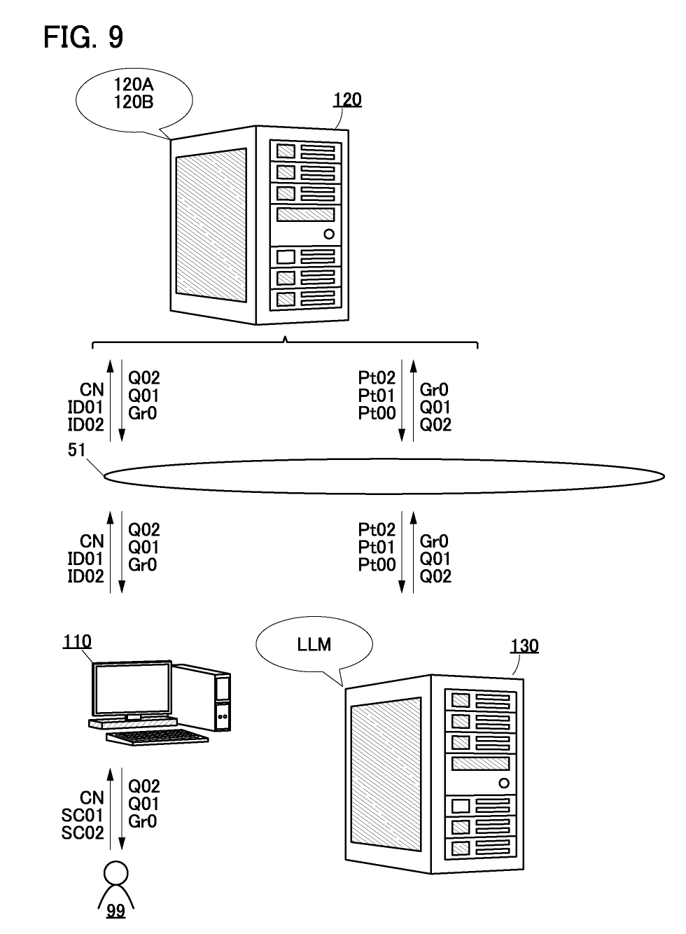

FIG. 9 is a diagram illustrating a structure of the information processing system according to one embodiment of the present invention.

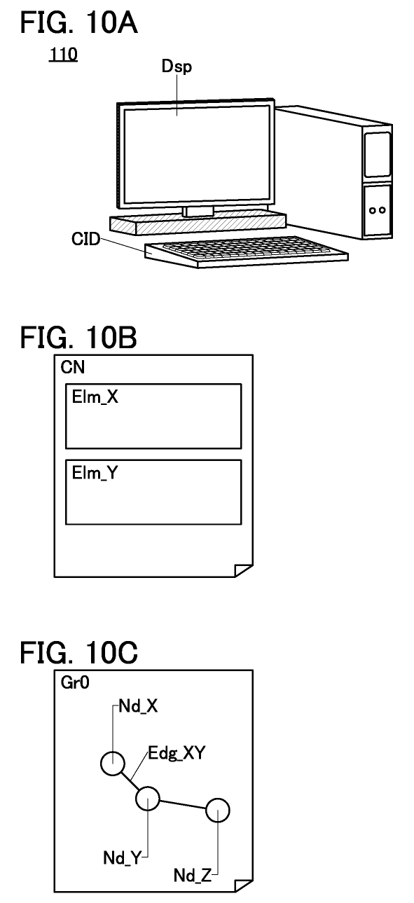

FIG. 10A is a diagram illustrating a structure of a component that can be used for the information processing system according to one embodiment of the present invention, FIG. 10B is a diagram illustrating a structure of a material received by the information processing system according to one embodiment of the present invention, and FIG. 10C is a diagram illustrating a structure of a graph provided by the information processing system according to one embodiment of the present invention.

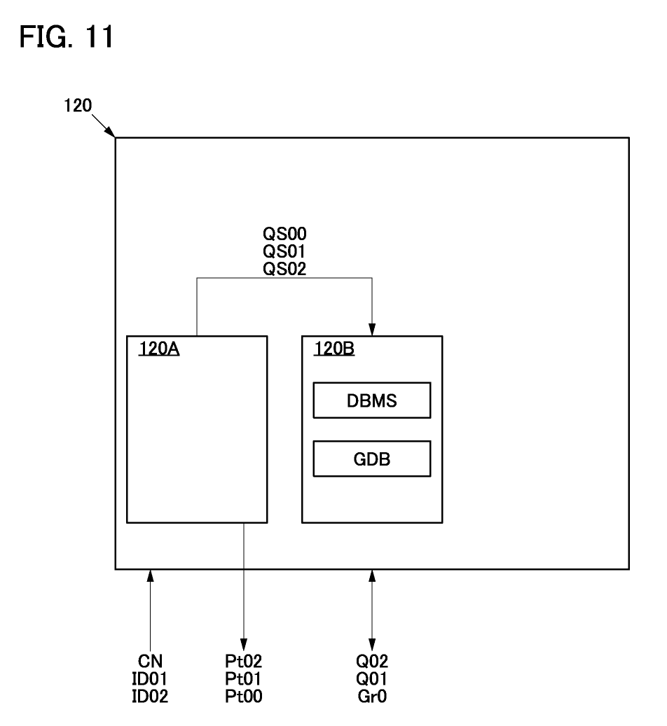

FIG. 11 is a diagram illustrating a structure of the component that can be used in the information processing system according to one embodiment of the present invention.

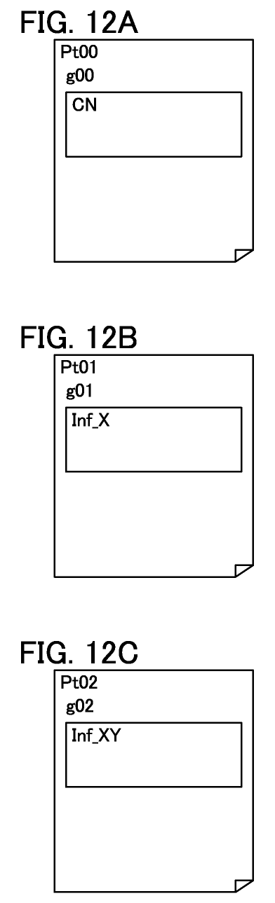

FIGS. 12A = 12C are diagrams each illustrating a structure of a prompt that is transmitted and received inside the information processing system according to one embodiment of the present invention.

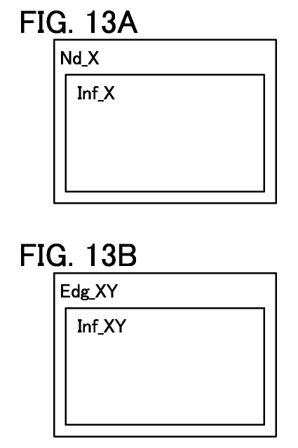

FIG. 13A is a diagram illustrating a structure of information stored in a node of a graph that can be used for the information processing system, and FIG. 13B is a diagram illustrating a structure of information stored in an edge of a graph that can be used for the information processing system.

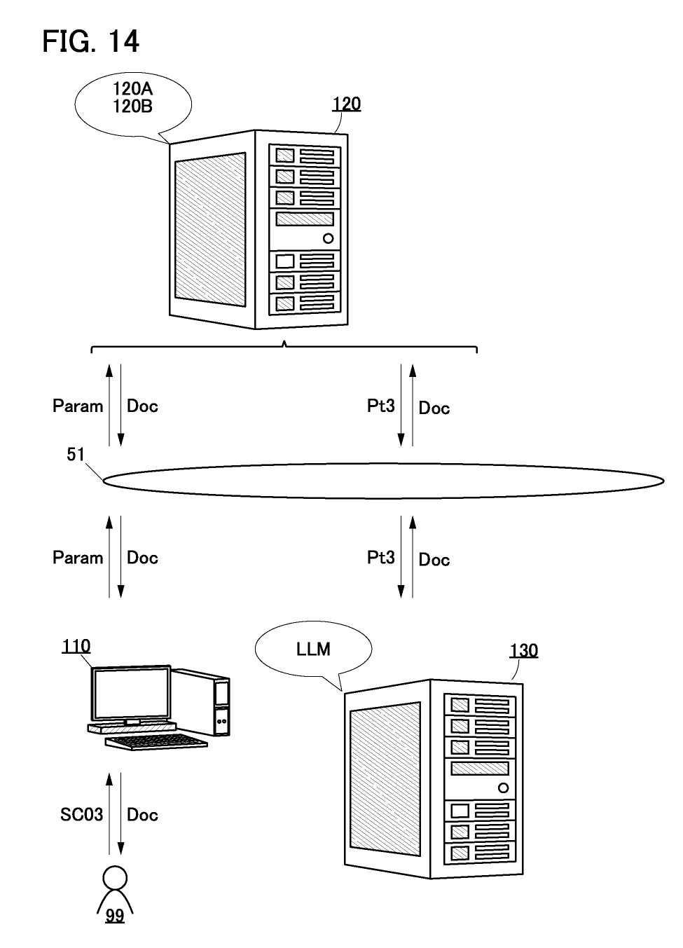

FIG. 14 is a diagram illustrating a structure of the information processing system according to one embodiment of the present invention.

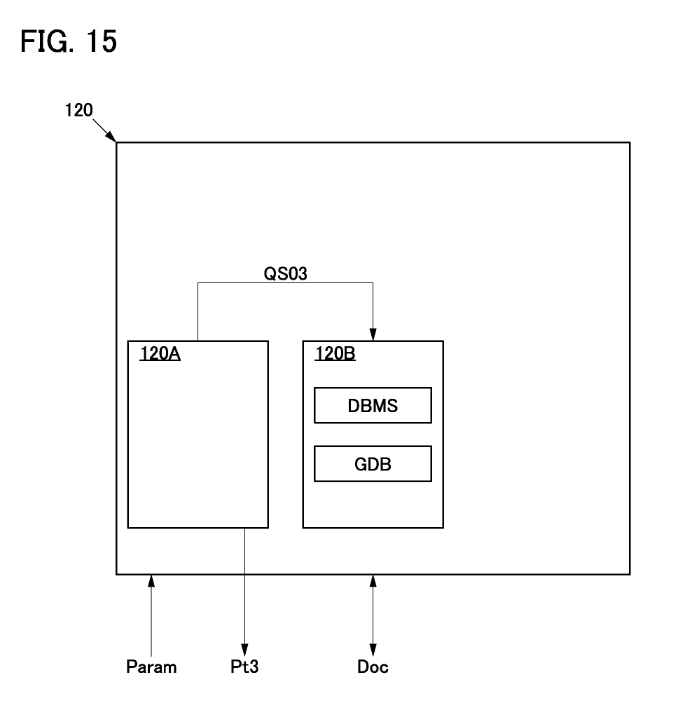

FIG. 15 is a diagram illustrating a structure of a component that can be used in the information processing system according to one embodiment of the present invention.

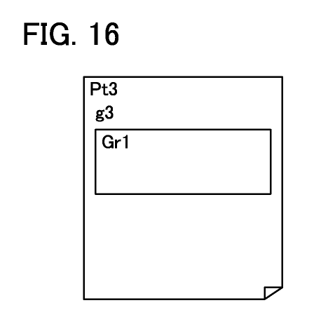

FIG. 16 is a diagram illustrating a structure of a prompt transmitted and received inside the information processing system according to one embodiment of the present invention.

FIG. 17 is a block diagram illustrating a structure of an information processing device that can be used for the information processing system according to one embodiment of the present invention.

<Structure example 1 of information processing system>
The information processing system according to one embodiment of the present invention includes a component 110, a component 130, and a component 120 (see FIG. 1).

An information processing device having a function of the component 110, an information processing device having a function of the component 130, and an information processing device having a function of the component 120 each include an arithmetic device and a communication device, for example. The communication devices in the information processing devices can be connected to one another via a network 51 to construct the information processing system according to one embodiment of the present invention.

<Structure example 1 of component 110>
The component 110 has a function of receiving a material Mtrl and transmitting the material Mtrl to the component 120.

For example, a material showing how an invention is carried out can be used as the material Mtrl.

For example, a user 99 of the information processing system inputs the material Mtrl to the component 110. Alternatively, the user 99 of the information processing system inputs, to the component 110, a command for selecting the material Mtrl from a variety of memory devices and transmitting the material Mtrl to the component 120, for example. Specifically, the user 99 of the information processing system inputs the command to the component 110 with the use of an input device such as a keyboard, a mouse, a facsimile device, or an eye-gaze input device.

In addition, the component 110 has a function of receiving a graph Gr1 and providing the graph Gr1 to the user 99 of the information processing system, for example. Specifically, with the use of an output device such as a display device, a speaker, a printer, a facsimile device, or a variety of memory devices, the graph Gr1 is provided to the user 99 of the information processing system. For example, in the case where the graph Gr1 described in a graph description language is received, the graph Gr1 can be displayed on the display device using an application installed on the component 110. Specifically, the graph Gr1 described in a DOT language can be displayed using the application called Graphviz. The graph Gr1 described in the DOT language can be displayed using the Python library matplotlib.

Note that the component 110 includes a display device Dsp and an input device CID, for example (see FIG. 2A). The display device Dsp has a function of displaying the material Mtrl, for example. The display device Dsp also has a function of displaying the graph Gr1, for example. Specifically, a display device using a liquid crystal as a display element, a display device using a light-emitting diode for a display element, a display device using an organic electroluminescent element, or the like can be used as the display device Dsp.

<<Structure example of material Mtrl>>
The material Mtrl includes a document Txt1 and a diagram Org1 (see FIG. 2B).

The document Txt1 includes, for example, information describing an element Elm_A and information describing an element Elm_B (see FIG. 3A). Note that the properties, characteristics, an attribute, a function, and the like of one element can be used for the information describing the component. The information is expressed in a sentence or a paragraph of the document Txt1. Furthermore, information describing one step and information describing another step can be used for the document Txt1.

The diagram Org1 includes, for example, a diagram illustrating the element Elm_A, the element Elm_B, and a relation between the element Elm_A and the element Elm_B (see FIG. 3B). Note that the shape, size, position, arrangement, direction, and the like can be illustrated. Specifically, the diagram can describe that the element Elm_A has a triangular shape, the element Elm_B has a quadrangular shape, and the element Elm_A is in contact with the element Elm_B.

<<Structure example of graph Gr1>>
The graph Gr1 includes a node Nd_A, a node Nd_B, and an edge Edg_AB connecting the node Nd_A and the node Nd_B (see FIG. 2C).

The node Nd_A has a function of storing information Inf_A relating to the element Elm_A (see FIG. 4A). For example, the node Nd_A has a function of storing the information Inf_A in a form of an attribute value pair.

The node Nd_B has a function of storing information Inf_B relating to the element Elm_B (see FIG. 4B). For example, the node Nd_B has a function of storing the information Inf_B in a form of an attribute value pair.

The edge Edg_AB has a function of storing information Inf_AB relating to the relation between the element Elm_A and the element Elm_B (see FIG. 4C). For example, the edge Edg_AB has a function of storing the information Inf_AB in a form of an attribute value pair.

<Structure example 1 of component 130>
The component 130 has a function of receiving a prompt Pt11 and transmitting an interpretation sentence IT to the component 120 and a function of receiving a prompt Pt12 and transmitting the graph Grl to the component 120. In addition, the component 130 has a function of performing processing using a vision language model VLM (see FIG. 1).

<<Structure example 1 of vision language model VLM>>
The vision language model VLM has a function of generating the interpretation sentence IT in accordance with the prompt Pt11 and a function of generating the graph Gr1 in accordance with the prompt Pt12.

A model in which a large language model and a vision model are combined can be used as the vision language model VLM. The large language model is a language model that has learned using a large amount of document data. The vision language model VLM can generate, from a document described in a natural language and an image, an explanatory sentence that relates to the image and is written in a natural language. For example, a vision language model such as GPT-4 (registered trademark), Gemini, or Llama4 can be used. Note that in this specification, character information described by characters is referred to as a document. The document includes characters, character strings, sentences, papers, and the like.

<Structure example 1 of component 120>
The component 120 has a function of receiving the material Mtrl and sharing the material Mtrl inside the component 120 (see FIG. 5).

The component 120 has a function of transmitting the prompt Pt11 to the component 130 and a function of receiving the interpretation sentence IT and sharing the interpretation sentence IT inside the component 120.

The component 120 has a function of transmitting the prompt Pt12 to the component 130 and a function of receiving the graph Gr1 and sharing the graph Gr1 inside the component 120.

In addition, the component 120 has a function of transmitting the graph Gr1 to the component 110.

The component 120 includes a subcomponent 120A and a subcomponent 120B. In this specification, a structure having a single function or a plurality of functions is referred to as a component or a subcomponent for description convenience. When a component includes a plurality of subcomponents and has a function of sharing information internally, the plurality of subcomponents can utilize the same information.

<<Structure example 1 of subcomponent 120A>>
The subcomponent 120A has a function of creating and executing a prompt chain PC1 and a function of creating a query sentence QS1. The prompt chain PC1 includes the prompt Pt11 and the prompt Pt12 (see FIG. 6A). Note that the prompt chain is a method in which a response to a prompt is used as part of the following prompt.

Structure example of prompt Pt11
The prompt Pt11 includes an instruction g11, the document Txt1, and the diagram Org1 (see FIG. 6B). The instruction g11 includes a procedure for generating the interpretation sentence IT from the diagram Org1 in consideration of the document Txt1.

Note that the interpretation sentence IT includes a natural language description of the element Elm_A, the element Elm_B, and the relation between the element Elm_A and the element Elm_B. The diagram Org1 can be encoded with the use of an encoder, and the diagram Org1 can further be pre-treated with the use of a tokenizer.

For example, a document in the next paragraph can be used as the prompt Pt11.

"Describe the diagram Org1 in as much detail as possible with reference to the document Txt1."

Structure example of prompt Pt12
The prompt Pt12 includes an instruction g12, the document Txt1, and the interpretation sentence IT (see FIG. 6C). The instruction g12 includes a procedure for generating the graph Gr1 from the document Txt1 and the interpretation sentence IT. Note that the graph Gr1 is described in a graph description language such as a DOT language, for example.

For example, a document in the next paragraph can be used as the prompt Pt12.

"Summarize a relation between elements from the interpretation sentence IT relating to the drawings in a graph with reference to the document Txt1. Describe the graph in a DOT language."

Structure example of query sentence QS1
The query sentence QS1 includes a request to register the graph Gr1 in a graph database with the use of a management system described later.

<<Structure example 1 of subcomponent 120B>>
The subcomponent 120B includes a management system DBMS and a graph database GDB (see FIG. 5).

[Structure example 1 of management system DBMS]
The management system DBMS has a function of registering the graph Gr1 in the graph database GDB in accordance with the query sentence QS1.

Accordingly, the interpretation sentence IT relating to the diagram Org1 can be generated from the material Mtrl. For example, the relation between the element Elm_A and the element Elm_B that is not included in the document Txt1 can be read from the diagram Org1. The element Elm_A, the element Elm_B, and the relation between the element Elm_A and the element Elm_B can be read from the material Mtrl. The element Elm_A, the element Elm_B, and the relation between the element Elm_A and the element Elm_B can be described in a natural language in the interpretation sentence IT. The element Elm_A, the element Elm_B, and the relation between the element Elm_A and the element Elm_B can be described in a graph description language in the graph Gr1. The graph Gr1 described in a graph description language can be provided and registered in the graph database GDB. An expression using a natural language of the user of the information processing system, for example, can be complemented with information taken from an expression using the diagram Org1. Additionally, for example, with the use of the graph Gr1, the information processing system can share a framework of the information with the user of the information processing system. Furthermore, for example, the material Mtrl modified by the user of the information processing system can be input and the graph Gr1 modified by the information processing system can be provided. Moreover, by repeating the above, the description can be improved. As a result, a novel information processing system that is highly convenient, useful, or reliable can be provided.

<Structure example 2 of component 110>
The component 110 has a function of receiving the interpretation sentence IT and providing the interpretation sentence IT to the user 99 of the information processing system, for example (see FIG. 1).

<Structure example 2 of component 120>
The component 120 has a function of transmitting the interpretation sentence IT to the component 110.

Accordingly, the interpretation sentence IT relating to the diagram Org1 can be generated from the material Mtrl. The interpretation sentence IT described in a natural language can be provided. As a result, a novel information processing system that is highly convenient, useful, or reliable can be provided.

<Structure example 3 of component 110>
The component 110 has a function of receiving a diagram Gen1 and an evaluation result Eva and providing the diagram Gen1 and the evaluation result Eva to the user 99 of the information processing system, for example (see FIG. 1).

<<Structure example of diagram Gen1>>
The diagram Gen1 illustrates the element Elm_A, the element Elm_B, and the relation between the element Elm_A and the element Elm_B (see FIG. 7B). Specifically, the diagram Gen1 illustrates that the element Elm_A has a triangular shape, the element Elm_B has a quadrangular shape, and the element Elm_A is in contact with the element Elm_B.

The evaluation result Eva includes the result of evaluating the diagram Gen1 on the basis of the diagram Org1. Note that the display device Dsp has a function of displaying the diagram Gen1 and the evaluation result Eva (see FIG. 7A), for example. Specifically, the embedding of the diagram Org1 and the embedding of the diagram Gen1 are received and the degree of similarly between them is calculated, and the calculated result can be used as the evaluation result Eva. For example, the cosine similarity can be used as the evaluation result Eva.

<Structure example 2 of component 130>
The component 130 has a function of receiving a prompt Pt21 and transmitting the diagram Gen1 to the component 120, and a function of receiving a prompt Pt22 and transmitting the evaluation result Eva to the component 120 (see FIG. 1).

<<Structure example 2 of vision language model VLM>>
The vision language model VLM has a function of generating the diagram Gen1 in accordance with the prompt Pt21 and a function of generating the evaluation result Eva in accordance with the prompt Pt22.

<Structure example 3 of component 120>
The component 120 has a function of transmitting the prompt Pt21 to the component 130 and a function of receiving the diagram Gen1 and sharing the diagram Gen1 inside the component 120.

The component 120 has a function of transmitting the prompt Pt22 to the component 130 and a function of receiving the evaluation result Eva and sharing the evaluation result Eva inside the component 120.

The component 120 has a function of transmitting the evaluation result Eva to the component 110.

<<Structure example 2 of subcomponent 120A>>
The subcomponent 120A has a function of creating and executing a prompt chain PC2. Note that the prompt chain PC2 includes the prompt Pt21 and the prompt Pt22 (see FIG. 8A).

Structure example of prompt Pt21
The prompt Pt21 includes an instruction g21 and the graph Gr1. The instruction g21 includes a procedure for generating the diagram Gen1 from the graph Gr1 (see FIG. 8B).

For example, a document in the next paragraph can be used as the prompt Pt21.

"Generate an image expressing the graph Gr1."

Note that the vision language model VLM may be made to generate a script and the diagram Gen1 may be generated with the use of another application.

Structure example of prompt Pt22
The prompt Pt22 includes an instruction g22, the diagram Org1, and the diagram Gen1 (see FIG. 8C). The instruction g22 includes a procedure for evaluating the diagram Gen1 on the basis of the diagram Org1. In other words, the instruction g22 includes a procedure for generating the evaluation result Eva.

For example, a document in the next paragraph can be used as the prompt Pt22.

"Explain the difference between the diagram Org1 and the diagram Gen1, and evaluate the degree of agreement as an image interpretation with a score out of 100."

Note that the vision language model VLM can be made to generate the embedding of the diagram Org1 and the embedding of the diagram Gen1 and transfer them to the component 120. The component 120 or the component 110 can calculate the evaluation result Eva with the use of the embedding of the diagram Org1 and the embedding of the diagram Gen1.

Accordingly, the diagram Gen1 can be generated from the graph Gr1 described in a graph description language. The element Elm_A, the element Elm_B, and the relation between the element Elm_A and the element Elm_B described in the graph Gr1 can be expressed in the diagram Gen1. The element Elm_A, the element Elm_B, and the relation between the element Elm_A and the element Elm_B expressed in the diagram Gen1 can be evaluated on the basis of the diagram Org1. Furthermore, the evaluation result Eva can be used for reinforcement learning of the vision language model VLM the information processing system. For example, the user of the information processing system can understand the interpretation of the material Mtrl by the information processing system through the diagram Gen1. For example, the user of the information processing system can recreate or complement the material Mtrl in accordance with the evaluation result Eva. For example, the user of the information processing system can complement the expressive ability using a natural language or the expressive ability using a diagram through interaction with the information processing system. As a result, a novel information processing system that is highly convenient, useful, or reliable can be provided.

<Structure example 4 of component 110>
The component 110 has a function of receiving the idea document CN and transmitting the idea document to the component 120 (see FIG. 9).

For example, the user 99 of the information processing system inputs the idea document CN to the component 110. Alternatively, the user 99 inputs, to the component 110, a command for selecting and transmitting the idea document CN stored in a variety of memory devices, for example. Specifically, the user 99 of the information processing system inputs the command to the component 110 with the use of an input device such as a keyboard, a mouse, a facsimile device, or an eye-gaze input device. Specifically, a memo pad relating to the invention that the user of the information processing system has come up with can be used as the idea document CN.

The component 110 has a function of receiving a graph Gr0 and transmitting the graph Gr0 to the user 99 of the information processing system, for example. Note that the display device Dsp has a function of displaying the graph Gr0, for example (see FIG. 10A).

<<Structure example of idea document CN>>
The idea document CN includes an element Elm_X (see FIG. 10B). For example, a bulleted list, a memo pad, a notebook, or the like describing how an invention is carried out can be used as the idea document CN. The invention described in the idea document CN includes the element Elm_X and an element Elm_Y.

<<Structure example of graph Gr0>>
The graph Gr0 includes a node Nd_X (see FIG. 10C). Note that the node Nd_X has a function of storing information relating to the element Elm_X (see FIG. 13A). For example, the node Nd_X has a function of storing, in a form of an attribute value pair, information Inf_X such as properties, characteristics, an attribute, a function, and a relation with another element described in a bulleted list explaining the element Elm_X.

The graph Gr0 includes a node Nd_Y and an edge Edg_XY (see FIG. 10C). The node Nd_Y has a function of storing information relating to the element Elm_Y. The edge Edg_XY has a function of storing information relating to a relation between the element Elm_X and the element Elm_Y (see FIG. 13B). For example, the edge Edg_XY has a function of storing, in a form of an attribute value pair, the information Inf_XY such as a positional relation between the element Elm_X and the element Elm_Y described in a bulleted list explaining the relation between the element Elm_X and the element Elm_Y.

<Structure example 3 of component 130>
The component 130 has a function of receiving a prompt Pt00 and transmitting the graph Gr0 to the component 120, and a function of performing processing using the large language model LLM (see FIG. 9).

<<Structure example 1 of large language model LLM>>
The large language model LLM has a function of generating the graph Gr0 in accordance with the prompt Pt00. Note that the graph Gr0 can be generated using the vision language model VLM instead of using the large language model LLM.

<Structure example 4 of component 120>
The component 120 has a function of receiving the idea document CN and sharing the idea document CN inside the component 120 (see FIG. 11).

The component 120 has a function of transmitting the prompt Pt00 to the component 130 and a function of receiving the graph Gr0 and sharing the graph Gr0 inside the component 120.

The component 120 has a function of transmitting the graph Gr0 to the component 110.

<<Structure example 3 of subcomponent 120A>>
The subcomponent 120A has a function of creating the prompt Pt00 and a function of creating a query sentence QS00.

Structure example of prompt Pt00
The prompt Pt00 includes an instruction g00 and the idea document CN (see FIG. 12A). The instruction g00 includes a procedure for generating the graph Gr0 from the idea document CN. Note that the graph Gr0 is described in a graph description language.

For example, a document in the next paragraph can be used as the prompt Pt00.

"Regarding the idea document CN, summarize procedures, elements, a relation between the procedures, a relation between the elements, and the like in as much detail as possible in a graph. Describe the graph in a DOT language."

Structure example of query sentence QS00
The query sentence QS00 includes a request to register the graph Gr0.

Structure example 2 of management system DBMS
The management system DBMS has a function of registering the graph Gr0 in the graph database GDB in accordance with the query sentence QS00 (see FIG. 11).

Accordingly, information relating to the element Elm_X described in the idea document CN can be stored in the node Nd_X of the graph Gr0. Moreover, the graph Gr0 can be generated from the idea document CN. For example, the user of the information processing system can be provided with the graph Gr0. The graph Gr0 can be registered in the graph database GDB. As a result, a novel information processing system that is highly convenient, useful, or reliable can be provided.

<Structure example 5 of component 110>
The component 110 has a function of receiving a selection command SC01 and transmitting specifying information ID01 to the component 120. For example, the user 99 of the information processing system can select an icon displayed on the display device Dsp with the use of a pointer and input the selection command SC01.

The component 110 has a function of receiving a question Q01 and providing the question Q01 to the user 99 of the information processing system, for example (see FIG. 9).

Note that the specifying information ID01 includes information specifying the node Nd_X of the graph Gr0. The question Q01 includes a question relating to the element Elm_X. Thus, for example, the user 99 of the information processing system can recognize a portion that is insufficient in the description or explanation in the material Mtrl, a portion of the material Mtrl that is difficult to understand, or the like. For example, the user 99 of the information processing system can recreate or supplement the material Mtrl.

<Structure example 4 of component 130>
The component 130 has a function of receiving a prompt Pt01 and transmitting the question Q01 to the component 120 (see FIG. 9).

<<Structure example 2 of large language model LLM>>
The large language model LLM has a function of generating the question Q01 in accordance with the prompt Pt01. Note that the question Q01 can be generated using the vision language model VLM instead of using the large language model LLM.

<Structure example 5 of component 120>
The component 120 has a function of receiving the specifying information ID01 and transmitting the prompt Pt01 to the component 130 and a function of receiving the question Q01 and transmitting the question Q01 to the component 110 (see FIG. 11).

<<Structure example 4 of subcomponent 120A>>
The subcomponent 120A has a function of creating a query sentence QS01 and the prompt Pt01.

Structure example of query sentence QS01
The query sentence QS01 includes a request to obtain the information Inf_X that relates to the element Elm_X and is stored in the node Nd_X on the basis of the specifying information ID01.

Structure example of prompt Pt01
The prompt Pt01 includes an instruction g01 and the information Inf_X (see FIG. 12B). The instruction g01 includes a procedure for generating the question Q01 regarding the information Inf_X.

For example, a document in the next paragraph can be used as the prompt Pt01.

"If the information on the element Elm_X that is stored in the node Nd_X of the graph Gr0 is insufficient, create a question to supplement the information."

Structure example 3 of management system DBMS
The management system DBMS has a function of obtaining the information Inf_X from the graph database GDB in accordance with the query sentence QS01 (see FIG. 11).

Accordingly, the information Inf_X relating to the element Elm_X can be obtained from the graph Gr0 on the basis of the specifying information ID01. In addition, the question Q01 regarding the information Inf_X on the element Elm_X can be generated. As a result, a novel information processing system that is highly convenient, useful, or reliable can be provided.

<Structure example 6 of component 110>
The component 110 has a function of receiving a selection command SC02 and transmitting specifying information ID02 to the component 120. For example, the user 99 of the information processing system can select an icon displayed on the display device Dsp with the use of a pointer and input the selection command SC02.

The component 110 has a function of receiving a question Q02 and providing the question Q02 to the user 99 of the information processing system, for example (see FIG. 9).

Note that the specifying information ID02 includes information specifying the edge Edg_XY of the graph Gr0. The question Q02 includes a question relating to the relation between the element Elm_X and the element Elm_Y. Thus, for example, the user 99 of the information processing system can recognize a portion that is insufficient in the description or explanation in the material Mtrl, a portion of the material Mtrl that is difficult to understand, or the like. For example, the user 99 of the information processing system can recreate or supplement the material Mtrl.

<Structure example 5 of component 130>
The component 130 has a function of receiving a prompt Pt02 and transmitting the question Q02 to the component 120.

<<Structure example 3 of large language model LLM>>
The large language model LLM has a function of generating the question Q02 in accordance with the prompt Pt02. Note that the question Q02 can be generated with the use of the vision language model VLM instead of using the large language model LLM.

<Structure example 6 of component 120>
The component 120 has a function of receiving the specifying information ID02 and transmitting the prompt Pt02 to the component 130 and a function of receiving the question Q02 and transmitting the question Q02 to the component 110.

<<Structure example 4 of subcomponent 120A>>
The subcomponent 120A has a function of creating a query sentence QS02 and the prompt Pt02.

Structure example of query sentence QS02
The query sentence QS02 includes a request to obtain the information Inf_XY that is related to the relation between the element Elm_X and the element Elm_Y and is stored in the Edg_XY on the basis of the specifying information ID02.

Structure example of prompt Pt02
The prompt Pt02 includes an instruction g02 and the information Inf_XY (see FIG. 12C). The instruction g02 includes a procedure for generating the question Q02 regarding the information Inf_XY.

For example, a document in the next paragraph can be used as the prompt Pt02.

"If the information on the relation between the element Elm_X and the element Elm_Y that is stored in the edge Edg_XY of the graph Gr0 is insufficient, create a question to supplement the information."

Structure example 4 of management system DBMS
The management system DBMS has a function of obtaining the information Inf_XY from the graph database GDB in accordance with the query sentence QS02.

Accordingly, the information Inf_XY relating to the relation between the element Elm_X and the element Elm_Y can be obtained from the graph Gr0 on the basis of the specifying information ID02. In addition, the question Q02 regarding the information Inf_XY on the relation between the element Elm_X and the element Elm_Y can be generated. As a result, a novel information processing system that is highly convenient, useful, or reliable can be provided.

<Structure example 7 of component 110>
The component 110 has a function of receiving a selection command SC03 and transmitting a parameter Param to the component 120. For example, the user 99 of the information processing system can select an icon displayed on the display device Dsp with the use of a pointer and input the selection command SC03.

The component 110 has a function of receiving a document Doc and providing the document Doc to the user 99 of the information processing system, for example (see FIG. 14).

Note that the parameter Param includes information for starting generation of the document Doc. The document Doc includes a description relating to the element Elm_A, the element Elm_B, and the relation between the element Elm_A and the element Elm_B.

<Structure example 6 of component 130>
The component 130 has a function of receiving a prompt Pt3 and transmitting the document Doc to the component 120 and a function of performing processing with use of the large language model LLM.

<<Structure example 4 of large language model LLM>>
The large language model LLM has a function of generating the document Doc in accordance with the prompt Pt3. Note that the document Doc can be generated using the vision language model VLM instead of using the large language model LLM.

<Structure example 7 of component 120>
The component 120 has a function of receiving the parameter Param and transmitting the prompt Pt3 to the component 130 and a function of receiving the document Doc and transmitting the document Doc to the component 110 (see FIG. 15).

<<Structure example 5 of subcomponent 120A>>
The subcomponent 120A has a function of creating a query sentence QS3 and the prompt Pt3.

Structure example of query sentence QS03
The query sentence QS3 includes a request to obtain the graph Gr1 from the graph database GDB.

Structure example of prompt Pt3
The prompt Pt3 includes an instruction g3 and the graph Gr1 (see FIG. 16). The instruction g3 includes a procedure for generating the document Doc from the graph Gr1.

For example, a document in the next paragraph can be used as the prompt Pt3.

"Create sentences describing a procedure or an element on the basis of the graph Gr1. Use all the pieces of information of the nodes and the edge of the graph Gr1."

Accordingly, the document Doc including the description relating to the element Elm_A, the element Elm_B, and the relation between the element Elm_A and the element Elm_B can be generated from the material Mtrl. For example, a specification of a patent application document can be generated from the material Mtrl. As a result, a novel information processing system that is highly convenient, useful, or reliable can be provided.

<Structure example 2 of information processing system>
The information processing system described in this embodiment includes the component 110, the component 120, and the component 130 (see FIG. 1).

The information processing system according to one embodiment of the present invention can be constituted with an information processing device having a function of the component 110, an information processing device having a function of the component 120, and an information processing device having a function of the component 130, for example. Note that the number of information processing devices constituting the information processing system according to one embodiment of the present invention is one or more. For example, a plurality of information processing devices can be connected to each other using the network 51 to constitute the information processing system according to one embodiment of the present invention.

When the information processing system according to one embodiment of the present invention is constituted with the plurality of information processing devices, loads relating to information processing can be dispersed.

<Structure example 1 of information processing device>
Structure example 1 of the information processing device described in this embodiment can be used as the component 110. The information processing device with Structure example 1 can be referred to as a client computer or the like. For example, a desktop computer or a mobile computer can be used as the component 110.

Structure example 1 of the information processing device can receive data input by the user of the information processing system according to one embodiment of the present invention. Structure example 1 of the information processing device can provide data output from the information processing system according to one embodiment of the present invention to the user.

For example, dedicated application software or a web browser operates in the component 110. Via either of them, the user of the information processing system according to one embodiment of the present invention can access the information processing system. Thus, the user can receive service using the information processing system according to one embodiment of the present invention.

<Structure example 2 of information processing device>
Structure example 2 of the information processing device described in this embodiment can be used as the component 120. For example, a workstation, a server computer, or a supercomputer can be used as the component 120.

Structure example 2 of the information processing device preferably has a function of a parallel computer. When the information processing device with this structure is used as a parallel computer, large-scale computation necessary for artificial intelligence (AI) learning and inference can be performed, for example.

Furthermore, the information processing device with Structure example 2 can perform processing using a natural language model with the use of AI.

For example, it is preferable that the information processing device be capable of performing processing using a natural language model such as GPT-3 (registered trademark), GPT-3.5, GPT-4 (registered trademark), LaMDA, Llama2, or Llama3.

<Structure example 3 of information processing device>
Structure example 3 of the information processing device described in this embodiment can be used as the component 130, for example. Note that the component 130 has a larger scale and higher computational capability than the component 120. For example, a large computer such as a server computer or a supercomputer can be used as the component 130.

Structure example 3 of the information processing device preferably has a function of a parallel computer. When the information processing device with this structure is used as a parallel computer, large-scale computation necessary for AI learning and inference can be performed, for example.

Furthermore, Structure example 3 of the information processing device can perform processing using a natural language model with the use of AI. In particular, it is possible to perform processing using a general-purpose language model capable of performing a variety of natural language processing tasks.

For example, processing using a natural language model such as GPT-3 (registered trademark), GPT-3.5, GPT-4 (registered trademark), LaMDA, Llama2, or Llama3 can be performed. In particular, it is preferable to execute processing with the use of GPT-4 (registered trademark). For example, processing using a language model that is larger in scale than a conventional natural language model can achieve more natural document generation, interaction, or the like.

Note that a service provider using the information processing system according to one embodiment of the present invention does not necessarily have its own Structure example 3 of the information processing device. For example, a service provider can utilize part of the service that another company or the like provides using Structure example 3 of the information processing device.

<Structure example of network 51>
The network 51 that can be used for the information processing system according to one embodiment of the present invention can connect the plurality of information processing devices to each other. Thus, the plurality of information processing devices connected to each other can transmit and receive data to and from each other. Furthermore, loads of the information processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the information processing system according to one embodiment of the present invention can provide service using the information processing method according to one embodiment of the present invention via the network 51, for example.

Note that in the case where the information processing system according to one embodiment of the present invention is constructed in a local network, the possibility of leakage of confidential information can be lower than that in the case of utilizing the Internet, for example.

<Structure example 4 of information processing device>
An information processing device 20 that can be used in the information processing system according to one embodiment of the present invention includes, for example, an input unit 21, a memory unit 22, a processing unit 23, an output unit 24, and a transmission path 25 (see FIG. 17).

Note that in a block diagram attached to this specification, elements are classified according to their functions and shown as independent blocks; however, it is practically difficult to completely separate the elements according to their functions, and one element can relate to a plurality of functions. For example, part of the processing unit 23 functions as the input unit 21 in some cases. In addition, one function can be involved in a plurality of elements. For example, processing performed in the processing unit 23 is sometimes executed by a different information processing device depending on the processing.

<Input unit 21>
The input unit 21 can receive data from the outside of the information processing device. For example, the input unit 21 receives data via the network 51. Specifically, a device such as a personal computer having a communication port or a communication function can be used.

The input unit 21 supplies the received data to one or both of the memory unit 22 and the processing unit 23 via the transmission path 25.

<Memory unit 22>
The memory unit 22 has a function of storing a program to be executed by the processing unit 23. The memory unit 22 can also have a function of storing data generated by the processing unit 23 (e.g., an arithmetic operation result, an analysis result, or an inference result), data received by the input unit 21, and the like.

The memory unit 22 can include a database. The information processing device can include a database in addition to the memory unit 22. The information processing device can have a function of extracting data from a database outside the memory unit 22, the information processing device, or the information processing system. Alternatively, the information processing device can have a function of extracting data from both of its own database and an external database.

One or both of a storage and a file server can be used as the memory unit 22. In addition, a database in which a path of a file stored in the file server is recorded can be used as the memory unit 22.

The memory unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The memory unit 22 can include at least one of a NOSRAM (registered trademark) and a DOSRAM (registered trademark). The memory unit 22 can include a storage media drive. Examples of the storage media drive include a hard disk drive (HDD) and a solid state drive (SSD).

Note that NOSRAM stands for "nonvolatile oxide semiconductor random access memory (RAM)". A NOSRAM refers to a memory in which a two-transistor (2T) or three-transistor (3T) gain cell is used as a memory cell and the transistor includes a metal oxide in its channel formation region (such a transistor is also referred to as an OS transistor). A current flowing between a source and a drain in an off state, that is, a leakage current, is extremely low in an OS transistor. A NOSRAM retains, in memory cells, electric charge corresponding to data with the use of a characteristic of an extremely low leakage current, and thus can be used as a nonvolatile memory. In particular, a NOSRAM is capable of reading retained data without destruction (non-destructive reading), and thus is suitable for arithmetic processing in which only data reading operations are repeated many times. A NOSRAM can have large data capacity when stacked in layers, and thus, a semiconductor device in which a NOSRAM is used for a large-scale cache memory, a large-scale main memory, or a large-scale storage memory can have higher performance.

Note that a non-transitory computer readable storage medium can be considered as an example of a memory included in the memory unit 22.

DOSRAM is an abbreviation of "dynamic oxide semiconductor RAM" and refers to a RAM including a one-transistor (1T) and one-capacitor (1C) memory cell. A DOSRAM is a DRAM formed using an OS transistor and temporarily stores information transmitted from the outside. A DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOx) or indium gallium zinc oxide (In–Ga–Zn oxide, also referred to as "IGZO") can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high binding energy with oxygen. The element M is, for example, an element that has higher binding energy with oxygen than indium does. The metal oxide included in the channel formation region is preferably a metal oxide containing zinc (Zn). The metal oxide containing zinc is easily crystallized in some cases.

The metal oxide included in the channel formation region is not limited to the metal oxide containing indium. For example, the metal oxide included in the channel formation region may be a metal oxide that does not include indium and includes zinc, a metal oxide that includes gallium, or a metal oxide that includes tin, e.g., zinc tin oxide or gallium tin oxide.

<Processing unit 23>
The processing unit 23 has a function of performing processing such as arithmetic operation, analysis, and inference with the use of data supplied from one or both of the input unit 21 and the memory unit 22. The processing unit 23 can supply generated data (e.g., an arithmetic operation result, an analysis result, or an inference result) to one or both of the memory unit 22 and the output unit 24.

The processing unit 23 has a function of obtaining data from the memory unit 22. The processing unit 23 can also have a function of storing or registering data in the memory unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to process various kinds of data and control programs. The programs to be executed by the processor are stored in at least one of the memory unit 22 and a memory region of the processor.

The processing unit 23 can include a main memory. The main memory includes at least one of a volatile memory such as a RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the memory unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM), which can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When at least one of a register and a cache memory included in the processing unit has such a feature, the processing unit can be operated only when needed, and otherwise can be off while information processed immediately before turning off the processing unit is stored in the memory element. In other words, normally-off computing is possible and the power consumption of the information processing system can be reduced.

The information processing device preferably uses AI for at least part of its processing.

In particular, the information processing device preferably uses an artificial neural network (ANN, hereinafter also simply referred to as a neural network). The neural network is obtained with circuits (hardware) or programs (software).

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing information is referred to as "learning" in some cases.

In this specification and the like, drawing a new conclusion from a neural network formed with the connection strength obtained by learning is referred to as "inference" in some cases.

<Output unit 24>
The output unit 24 can output at least one of an arithmetic operation result, an analysis result, and an inference result in the processing unit 23 to the outside of the information processing device. For example, the output unit 24 can transmit data via the network 51. Specifically, a device such as a personal computer having a communication port or a communication function can be used. Furthermore, a device having a communication function may be used as the input unit 21 and the output unit 24.

<Transmission path 25>
The transmission path 25 has a function of transmitting data. Data transmission and reception between the input unit 21, the memory unit 22, the processing unit 23, and the output unit 24 can be performed via the transmission path 25. Specifically, an external bus, a LAN, or the Internet can be used for the transmission path 25.

Note that this embodiment can be combined with the other embodiment in this specification as appropriate.

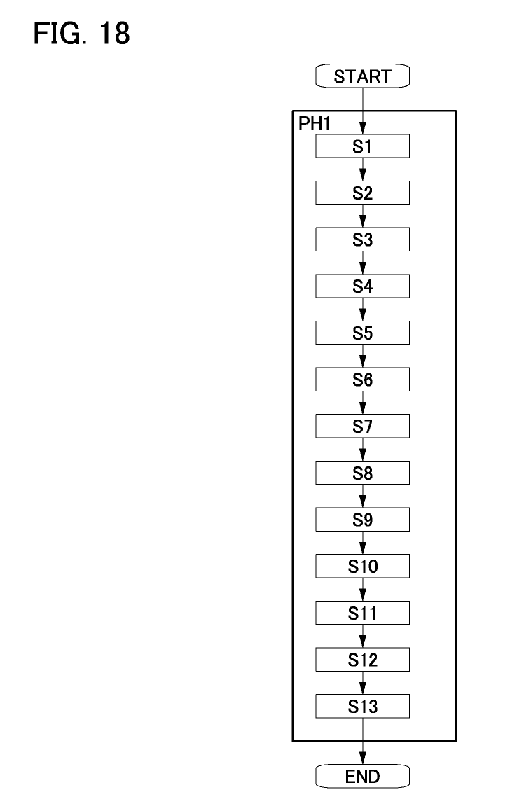

Embodiment 2
In this embodiment, an information processing method according to one embodiment of the present invention will be described with reference to FIG. 18 to FIG. 21.

FIG. 18 is a flow diagram showing the information processing method according to one embodiment of the present invention.

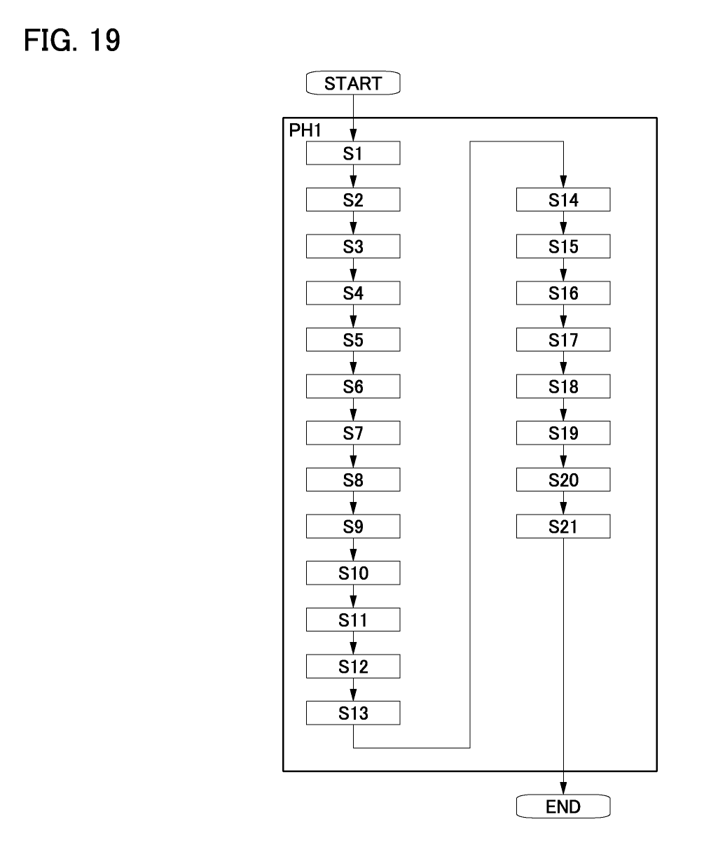

FIG. 19 is a flow diagram showing the information processing method according to one embodiment of the present invention.

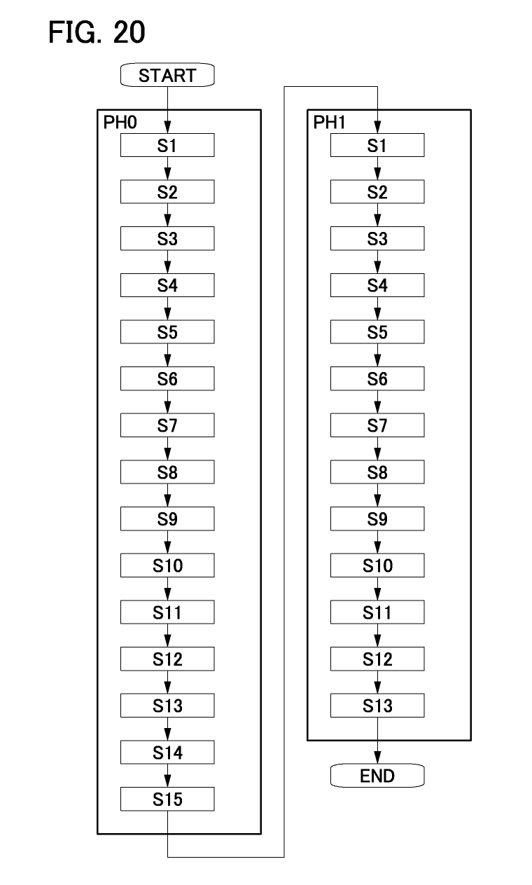

FIG. 20 is a flow diagram showing the information processing method according to one embodiment of the present invention.

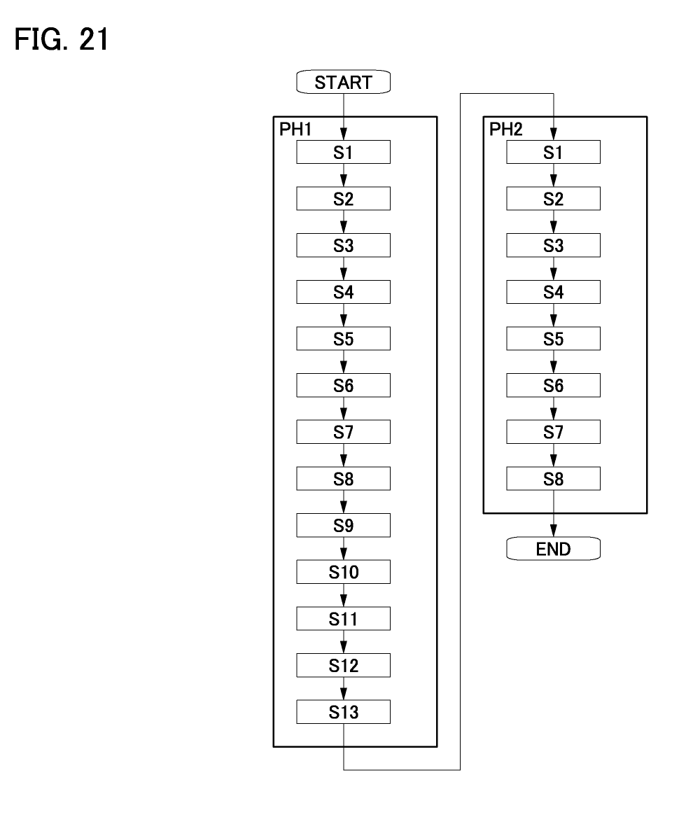

FIG. 21 is a flow diagram showing the information processing method according to one embodiment of the present invention.

<Example 1 of information processing method>
The information processing method according to one embodiment of the present invention includes Phase PH1.

<Phase PH1>
Phase PH1 includes Step S1 to Step S13 (see FIG. 18).

<<Step S1>>
In Step S1 of Phase PH1, the component 110 receives the material Mtrl and transmits the material Mtrl to the component 120. Note that the material Mtrl includes the document Txt1 and the diagram Org1.

The document Txt1 includes the element Elm_A and the element Elm_B. The diagram Org1 is a diagram illustrating the element Elm_A, the element Elm_B, and the relation between the element Elm_A and the element Elm_B.

For example, the user of the information processing method inputs the material Mtrl to the component 110. Alternatively, the user of the information processing method inputs, to the component 110, a command for selecting the material Mtrl from a variety of memory devices and transmitting the material Mtrl to the component 120, for example.

<<Step S2>>
In Step S2 of Phase PH1, the component 120 receives the material Mtrl and shares the material Mtrl inside the component 120. The component 120 includes the subcomponent 120A and the subcomponent 120B.

The subcomponent 120A has a function of creating and executing the prompt chain PC1 and a function of creating the query sentence QS1. The prompt chain PC1 includes the prompt Pt11 and the prompt Pt12.

The subcomponent 120B includes the graph database GDB and the management system DBMS.

<<Step S3>>
In Step S3 of Phase PH1, the subcomponent 120A creates the prompt Pt11 and transmits the prompt Pt11 to the component 130.

The prompt Pt11 includes the instruction g11, the document Txt1, and the diagram Org1. The instruction g11 includes a procedure for generating the interpretation sentence IT from the diagram Org1 in consideration of the document Txt1.

The interpretation sentence IT includes a natural language description of the element Elm_A, the element Elm_B, and the relation between the element Elm_A and the element Elm_B.

<<Step S4>>
In Step S4 of Phase PH1, the component 130 receives the prompt Pt11, generates the interpretation sentence IT with the use of the vision language model VLM, and transmits the interpretation sentence IT to the component 120.

<<Step S5>>
In Step S5 of Phase PH1, the component 120 receives the interpretation sentence IT and shares the interpretation sentence IT inside the component 120.

<<Step S6>>
In Step S6 of Phase PH1, the subcomponent 120A creates the prompt Pt12 and transmits the prompt Pt12 to the component 130.

The prompt Pt12 includes the instruction g12, the document Txt1, and the interpretation sentence IT. The instruction g12 includes a procedure for generating the graph Gr1 from the document Txt1 and the interpretation sentence IT. Note that the graph Gr1 is described in a graph description language.

<<Step S7>>
In Step S7 of Phase PH1, the component 130 receives the prompt Pt12, generates the graph Gr1 with the use of the vision language model VLM, and transmits the graph Gr1 to the component 120.

<<Step S8>>
In Step S8 of Phase PH1, the component 120 receives the graph Gr1 and shares the graph Gr1 inside the component 120.

<<Step S9>>
In Step S9 of Phase PH1, the subcomponent 120A creates the query sentence QS1. Note that the query sentence QS1 includes a request to register the graph Gr1.

<<Step S10>>
In Step S10 of Phase PH1, the subcomponent 120B creates the query sentence QS1 and shares the query sentence QS1 inside the component 120.

<<Step S11>>
In Step S11 of Phase PH1, the management system DBMS registers the graph Gr1 in the graph database GDB in accordance with the query sentence QS1.

<<Step S12>>
In Step S12 of Phase PH1, the component 120 transmits the graph Gr1 to the component 110.

<<Step S13>>
In Step S13 of Phase PH1, the component 110 receives the graph Gr1 and provides the graph Gr1 to the user of the information processing method, for example.

Accordingly, the interpretation sentence IT relating to the diagram Org1 can be generated from the material Mtrl. For example, a relation between the element Elm_A and the element Elm_B that is not included in the document Txt1 can be read from the diagram Org. The element Elm_A, the element Elm_B, and the relation between the element Elm_A and the element Elm_B can be read from the material. The element Elm_A, the element Elm_B, and the relation between the element Elm_A and the element Elm_B can be described in a natural language in the interpretation sentence. The element Elm_A, the element Elm_B, and the relation between the element Elm_A and the element Elm_B can be described in a graph description language in the graph Gr1. The graph Gr1 described in a graph description language can be provided and registered in the graph database GDB. An expression using a natural language of the user of the information processing system, for example, can be complemented with information taken from an expression using the diagram Org. Additionally, for example, with the use of the graph Gr1, the information processing system can share a framework of the information with the user of the information processing system. Furthermore, for example, the material Mtrl modified by the user of the information processing system can be input and the graph Gr1 modified by the information processing system can be provided. Moreover, by repeating the above, the description can be improved. As a result, a novel information processing method that is highly convenient, useful, or reliable can be provided.

<Example 2 of information processing method>
In Step S12 of Phase PH1 in the information processing method according to one embodiment of the present invention, the component 120 transmits the graph Gr1 and the interpretation sentence IT to the component 110 (see FIG. 18).

In Step S13 of Phase PH1, the component 110 receives the graph Gr1 and the interpretation sentence IT and provides the graph Gr1 and the interpretation sentence IT to the user of the information processing method, for example.

Thus, the interpretation sentence IT relating to the diagram Org1 can be generated from the material Mtrl. An interpretation sentence IT described in a natural language can be provided. As a result, a novel information processing method that is highly convenient, useful, or reliable can be provided.

<Example 3 of information processing method>
An information processing method according to one embodiment of the present invention includes Steps S14 to S21 in Phase PH1 (see FIG. 19).

Note that Step S14 of Phase PH1 follows Step S13 of Phase PH1. The subcomponent 120A has a function of creating and executing the prompt chain PC2, and the prompt chain PC2 includes the prompt Pt21 and the prompt Pt22.

<<Step S14>>
In Step S14 of Phase PH1, the subcomponent 120A creates the prompt Pt21 and transmit the prompt Pt21 to the component 130.

The prompt Pt21 includes the instruction g21 and the graph Gr1. The instruction g21 includes a procedure for generating the diagram Gen1 from the graph Gr1.

<<Step S15>>
In Step S15 of Phase PH1, the component 130 receives the prompt Pt1, generates the diagram Gen1 with the use of the vision language model VLM, and transmits the diagram Gen1 to the component 120.

<<Step S16>>
In Step S16 of Phase PH1, the component 120 receives the diagram Gen1 and shares the diagram Gen1 inside the component 120.

<<Step S17>>
In Step S17 of Phase PH1, the subcomponent 120A creates the prompt Pt22 and transmits the prompt Pt22 to the component 130.

The prompt Pt22 includes the instruction g22, the diagram Org1, and the diagram Gen1. The instruction g22 includes a procedure for evaluating the diagram Gen1 on the basis of the diagram Org1. In other words, the instruction g22 includes a procedure for generating the evaluation result Eva.

<<Step S18>>
In Step S18 of Phase PH1, the component 130 receives the prompt Pt22, generates the evaluation result Eva in accordance with the prompt Pt22 with the use of the vision language model VLM, and transmits the evaluation result Eva to the component 120.

<<Step S19>>
In Step S19 of Phase PH1, the component 120 receives the evaluation result Eva and shares the evaluation result Eva inside the component 120.

<<Step S20>>
In Step S20 of Phase PH1, the component 120 transmits the diagram Gen1 and the evaluation result Eva to the component 110.

<<Step S21>>
In Step S21 of Phase PH1, the component 110 receives the diagram Gen1 and the evaluation result Eva and provides the diagram Gen1 and the evaluation result Eva to the user of the information processing method, for example.

Accordingly, the diagram Gen1 can be generated from the graph Gr1 described in a graph description language. The element Elm_A, the element Elm_B, and the relation between the element Elm_A and the element Elm_B described in the graph Gr1 can be expressed in the diagram Gen1. Moreover, the element Elm_A, the element Elm_B, and the relation between the element Elm_A and the element Elm_B expressed in the diagram Gen1 can be evaluated on the basis of the diagram Org1. For example, with the use of the diagram Gen1, the information processing system can share a framework of information with the user of the information processing system. For example, the material modified by the user of the information processing system can be input and the diagram Gen1 modified by the information processing system can be provided. Moreover, by repeating the above, the description can be improved. As a result, a novel information processing method that is highly convenient, useful, or reliable can be provided.

<Example 4 of information processing method>
An information processing method according to one embodiment of the present invention further includes Phase PH0. Note that Phase PH1 follows Phase PH0.

<Phase PH0>
Phase PH0 includes Step S1 to Step S7 (see FIG. 20).

<<Step S1>>
In Step S1 of Phase PH0, the component 110 receives the idea document CN and transmits the idea document CN to the component 120.

For example, the user of the information processing method inputs the idea document CN to the component 110. Alternatively, the user of the information processing method inputs, to the component 110, a command for selecting and transmitting the idea document CN stored in the memory device, for example.

<<Step S2>>
In Step S2 of Phase PH0, the component 120 receives the idea document CN and shares the idea document CN inside the component 120. Note that the subcomponent 120A has a function of creating the prompt Pt00 and a function of creating the query sentence QS00.

<<Step S3>>
In Step S3 of Phase PH0, the subcomponent 120A creates the prompt Pt00 and transmits the prompt Pt00 to the component 130.

The prompt Pt00 includes the instruction g00 and the idea document CN. The instruction g00 includes a procedure for generating the graph Gr0 from the idea document CN. Note that the graph Gr0 is described in a graph description language.

<<Step S4>>
Step S4 of Phase PH0, the component 130 receives the prompt Pt00, generates the graph Gr0 with the use of the large language model LLM, and transmits the graph Gr0 to the component 120.

<<Step S5>>
In Step S5 of Phase PH0, the component 120 receives the graph Gr0 and shares the graph Gr0 inside the component 120.

<<Step S6>>
In Step S6 of Phase PH0, the subcomponent 120A creates the query sentence QS00 and shares the query sentence QS00 inside the component 120. Note that the query sentence QS00 includes a request to register the graph Gr0.

<<Step S7>>
In Step S7 of Phase PH0, the management system DBMS registers the graph Gr0 in the graph database GDB in accordance with the query sentence QS00.

Accordingly, information relating to the element Elm_X described in the idea document CN can be stored in the node Nd_X of the graph Gr0. Moreover, the graph Gr0 can be generated from the idea document CN. For example, the graph Gr0 can be provided to the user of the information processing method. The graph Gr0 can be registered in the graph database GDB. As a result, a novel information processing method that is highly convenient, useful, or reliable can be provided.

<Example 5 of information processing method>
An information processing method according to one embodiment of the present invention further includes Steps S8 to S15 in Phase PH0 (see FIG. 20). Note that Step S8 of Phase PH0 follows Step S7 of Phase PH0.

<<Step S8>>
In Step S8 of Phase PH0, the component 110 receives the selection command SC01 and transmits the specifying information ID01 to the component 120. Note that the specifying information ID01 includes information specifying the node Nd_X of the graph Gr0.

For example, the user of the information processing method selects an icon displayed on the display device Dsp with the use of a pointer and input the selection command SC01 to the component 110.

<<Step S9>>
In Step S9 of Phase PH0, the component 120 receives the specifying information ID01 and shares the specifying information ID01 inside the component 120.

<<Step S10>>
In Step S10 of Phase PH0, the subcomponent 120A creates the query sentence QS01 and shares the query sentence QS01 inside the component 120.

The query sentence QS01 includes a request to obtain the information Inf_X that relates to the element Elm_X and is stored in the node Nd_X on the basis of the specifying information ID01.

<<Step S11>>
In Step S11 of Phase PH0, the management system DBMS obtains the information Inf_X from the graph database GDB in accordance with the query sentence QS01 and share the information Inf_X inside the component 120.

<<Step S12>>
In Step S12 of Phase PH0, the subcomponent 120A creates the prompt Pt01 and transmits the prompt Pt01 to the component 130.

The prompt Pt01 includes the instruction g01 and the information Inf_X. The instruction g01 includes a procedure for generating the question Q01 regarding the information Inf_X.

<<Step S13>>
In Step S13 of Phase PH0, the component 130 receives the prompt Pt01, generates the question Q01 with the use of the large language model LLM, and transmits the question Q01 to the component 120.

<<Step S14>>
In Step S14 of Phase PH0, the component 120 receives the question Q01 and transmits the question Q01 to the component 110.

<<Step S15>>
In Step S15 of Phase PH0, the component 110 receives the question Q01 and provides the question Q01 to the user of the information processing system, for example.

Accordingly, the information Inf_X relating to the element Elm_X can be obtained from the graph Gr0 on the basis of the specifying information ID01. In addition, the question Q01 regarding the information Inf_X of the element Elm_X can be generated. As a result, a novel information processing method that is highly convenient, useful, or reliable can be provided.

<Example 6 of information processing method>
The information processing method according to one embodiment of the present invention includes Steps S8 to S15 in Phase PH0 (see FIG. 20). Note that Step S8 of Phase PH0 follows Step S7 of Phase PH0.

<<Step S8>>
In Step S8 of Phase PH0, the component 110 receives the selection command SC02 and transmits the specifying information ID02 to the component 120. Note that the specifying information ID02 includes information specifying the edge Edg_XY of the graph Gr0.

For example, the user of the information processing method selects an icon displayed on the display device Dsp with the use of a pointer, and inputs the selection command SC02 to the component 110.

<<Step S9>>
In Step S9 of Phase PH0, the component 120 receives the specified information ID02 and shares the specified information ID02 inside the component 120.

<<Step S10>>
In Step S10 of Phase PH0, the subcomponent 120A creates the query sentence QS02 and shares the query sentence QS02 inside the component 120.

The query sentence QS02 includes a request to obtain the information Inf_XY that relates to the relation between the element Elm_X and the element Elm_Y and is stored in the edge Edg_XY on the basis of the specifying information ID02.

<<Step S11>>
In Step S11 of Phase PH0, the management system DBMS obtains the information Inf_XY from the graph database GDB in accordance with the query sentence QS02 and shares the information Inf_XY inside the component 120.

<<Step S12>>
In Step S12 of Phase PH0, the subcomponent 120A creates the prompt Pt02 and transmits the prompt Pt02 to the component 130.

The prompt Pt02 includes the instruction g02 and the information Inf_XY. The instruction g02 includes a procedure for generating the question Q02 regarding the information Inf_XY.

<<Step S13>>
In Step S13 of Phase PH0, the component 130 receives the prompt Pt02, generates the question Q02 with the use of the large language model LLM, and transmits the question Q02 to the component 120.

<<Step S14>>
In Step S14 of Phase PH0, the component 120 receives the question Q02 and transmits the question Q02 to the component 110.

<<Step S15>>
In Step S15 of Phase PH0, the component 110 receives the question Q02 and provides the question Q02 to the user of the information processing method, for example.

Accordingly, the information Inf_XY relating to the relation between the element Elm_X and the element Elm_Y can be obtained from the graph Gr0 on the basis of the specifying information ID02. In addition, the question Q02 regarding the information Inf_XY on the relation between the element Elm_X and the element Elm_Y can be generated. As a result, a novel information processing method that is highly convenient, useful, or reliable can be provided.

<Example 7 of information processing method>
An information processing method according to one embodiment of the present invention includes Phase PH2. Note that Phase PH2 follows Phase PH1 (see FIG. 21).

<Phase PH2> '
Phase PH2 includes Step S1 to Step S8.

<<Step S1>>
In Step S1 of Phase PH2, the component 110 receives the selection command SC03 and transmits the parameter Param to the component 120.

For example, the user of the information processing method selects an icon displayed on the display device Dsp with the use of a pointer, and inputs the selection command SC03 to the component 110.

Note that the parameter Param includes information for starting generation of the document Doc. The document Doc includes a description relating to the element Elm_A, the element Elm_B, and the relation between the element Elm_A and the element Elm_B.

<<Step S2>>
In Step S2 of Phase PH2, the component 120 receives the parameter Param and shares the parameter Param inside the component 120.

<<Step S3>>
In Step S3 of Phase PH2, the subcomponent 120A creates the query sentence QS3 and shares the query sentence QS3 inside the component 120. Note that the query sentence QS3 includes a request to obtain the graph Gr1 from the graph database GDB.

<<Step S4>>
In Step S4 of Phase PH2, the management system DBMS obtains the graph Gr1 from the graph database GDB in accordance with the query sentence QS3 and shares the graph Gr1 inside the component 120.

<<Step S5>>
In Step S5 of Phase PH2, the subcomponent 120A creates the prompt Pt3 and transmits the prompt Pt3 to the component 130.

The prompt Pt3 includes the instruction g3 and the graph Gr1. The instruction g3 includes a procedure for generating the document Doc from the graph Gr1.

<<Step S6>>
In Step S6 of Phase PH2, the component 130 receives the prompt Pt3, generates the document Doc with the use of the large language model LLM, and transmits the document Doc to the component 120.

<<Step S7>>
In Step S7 of Phase PH2, the component 120 receives the document Doc and transmits the document Doc to the component 110.

<<Step S8>>
In Step S8 of Phase PH2, the component 110 receives the document Doc and provides the document Doc to the user of the information processing method, for example.

Accordingly, the document Doc including the description relating to the element Elm_A, the element Elm_B, and the relation between the element Elm_A and the element Elm_B can be generated from the material Mtrl. As a result, a novel information processing method that is highly convenient, useful, or reliable can be provided.

Note that this embodiment can be combined with the other embodiment in this specification as appropriate.

This application is based on Japanese Patent Application Serial No. 2025-072117 filed with Japan Patent Office on Apr. 24, 2025, the entire contents of which are hereby incorporated by reference.

What is claimed is:

1. An information processing system configured to receive a material and to provide a first graph,
wherein the material comprises a first document and a first diagram,
wherein the first document comprises a first element and a second element,
wherein the first diagram is a diagram illustrating the first element, the second element, and a relation between the first element and the second element,
wherein the first graph comprises a first node, a second node, and an edge,
wherein the first node is configured to store information relating to the first element,
wherein the second node is configured to store information relating to the second element, and
wherein the edge is configured to store information relating to the relation between the first element and the second element.

2. An information processing system comprising:
a first component configured to receive and transmit a material comprising a first document and a first diagram to the third component and to receive and provide a first graph;
a second component configured to receive a first prompt and a second prompt, to transmit an interpretation sentence and the first graph to the third component, and to perform processing using a vision language model configured to generate the interpretation sentence in accordance with the first prompt and to generate the first graph in accordance with the second prompt; and
a third component comprising a first subcomponent configured to create and execute a first prompt chain and to create a first query sentence and a second subcomponent comprising a management system and a graph database, the third component being configured to transmit the first prompt and the second prompt to the second component and to transmit the first graph to the first component,
wherein the first document comprises a first element and a second element,
wherein the first diagram is a diagram illustrating the first element, the second element, and a relation between the first element and the second element,
wherein the first graph comprises a first node, a second node, and an edge,
wherein the first node is configured to store information relating to the first element,
wherein the second node is configured to store information relating to the second element,
wherein the edge is configured to store information relating to the relation between the first element and the second element,
wherein the first prompt chain comprises the first prompt and the second prompt,
wherein the first prompt comprises a first instruction, the first document, and the first diagram,
wherein the first instruction comprises a procedure for generating the interpretation sentence from the first diagram in consideration of the first document,
wherein the interpretation sentence comprises a natural language description of the first element, the second element, and the relation between the first element and the second element,
wherein the second prompt comprises a second instruction, the first document, and the interpretation sentence,
wherein the second instruction comprises a procedure for generating the first graph from the first document and the interpretation sentence,
wherein the first graph is described in a graph description language,
wherein the first query sentence comprises a request to register the first graph, and
wherein the management system is configured to register the first graph in the graph database in accordance with the first query sentence.

3. The information processing system according to claim 2,
wherein the first component is configured to receive the interpretation sentence from the third component and to provide the interpretation sentence.

4. The information processing system according to claim 2,
wherein the first component is configured to receive and provide a second diagram illustrating the first element, the second element, and the relation between the first element and the second element and an evaluation result comprising a result of an evaluation of the second diagram based on the first diagram,
wherein the second component is configured to receive a third prompt and a fourth prompt and to transmit the second diagram and the evaluation result to the third component,
wherein the vision language model is configured to generate the second diagram in accordance with the third prompt and the evaluation result in accordance with the fourth prompt,
wherein the third component is configured to transmit the third prompt and the fourth prompt to the second component, and the evaluation result to the first component,
wherein the first subcomponent is configured to create and execute a second prompt chain comprising the third prompt and the fourth prompt,
wherein the third prompt comprises a third instruction and the first graph,
wherein the third instruction comprises a procedure for generating the second diagram from the first graph,
wherein the fourth prompt comprises a fourth instruction, the first diagram, and the second diagram, and
wherein the fourth instruction comprises a procedure for evaluating the second diagram based on the first diagram.

5. The information processing system according to claim 2,
wherein the first component is configured to receive and transmit an idea document comprising a third element to the third component and to receive and provide a second graph comprising a third node,
wherein the third node is configured to store information relating to the third element,
wherein the second component is configured to receive a fifth prompt, to transmit the second graph to the third component, and to perform processing using a large language model configured to generate the second graph in accordance with the fifth prompt,
wherein the third component is configured to transmit the fifth prompt to the second component and to transmit the second graph to the first component,
wherein the first subcomponent is configured to create the fifth prompt and a second query sentence,
wherein the fifth prompt comprises a fifth instruction and the idea document,
wherein the fifth instruction comprises a procedure for generating the second graph from the idea document,
wherein the second graph is described in the graph description language,
wherein the second query sentence comprises a request to register the second graph, and
wherein the management system is configured to register the second graph in the graph database in accordance with the second query sentence.

6. The information processing system according to claim 5,
wherein the first component is configured to receive a selection command, to transmit specifying information comprising information specifying the third node of the second graph to the third component, and to receive and provide a question comprising a question relating to the third element,
wherein the second component is configured to receive a sixth prompt and to transmit the question to the third component,
wherein the large language model is configured to generate the question in accordance with the sixth prompt,
wherein the third component is configured to transmit the sixth prompt to the second component and the question to the first component,
wherein the first subcomponent is configured to create a third query sentence and the sixth prompt,
wherein the third query sentence comprises a request to obtain information relating to the third element stored in the third node on the basis of the specifying information,
wherein the sixth prompt comprises a sixth instruction and the information,
wherein the sixth instruction comprises a procedure for generating the question regarding the information, and
wherein the management system is configured to obtain the information from the graph database in accordance with the third query sentence.

7. The information processing system according to claim 5,
wherein the first component is configured to receive a selection command, to transmit specifying information to the third component, and to receive and provide a question,
wherein the second graph comprises a fourth node configured to store information relating to a fourth element and a second edge configured to store information relating to a relation between the third element and the fourth element,
wherein the specifying information comprises information specifying the second edge of the second graph,
wherein the question comprises a question relating to the relation between the third element and the fourth element,
wherein the second component is configured to receive a sixth prompt and to transmit the question to the third component,
wherein the large language model is configured to generate the question in accordance with the sixth prompt,
wherein the third component is configured to transmit the sixth prompt to the second component and the question to the first component,
wherein the first subcomponent is configured to create a third query sentence and the sixth prompt,
wherein the third query sentence comprises a request to obtain information relating to the relation between the third element and the fourth element stored in the second edge on the basis of the specifying information,
wherein the sixth prompt comprises a sixth instruction and the information,
wherein the sixth instruction comprises a procedure for generating the question regarding the information, and
wherein the management system is configured to obtain the information from the graph database in accordance with the third query sentence.

8. The information processing system according to claim 2,
wherein the first component is configured to receive a selection command, to transmit a parameter to the third component, and to receive and provide a second document comprising a description relating to the first element, the second element, and the relation between the first element and the second element,
wherein the parameter comprises information for starting generation of the second document,
wherein the second component is configured to receive a third prompt, to transmit the second document to the third component, and to perform processing using a large language model configured to generate the second document in accordance with the third prompt,
wherein the third component is configured to transmit the third prompt to the second component and the second document to the first component,
wherein the first subcomponent is configured to create a second query sentence and the third prompt,
wherein the second query sentence comprises a request to obtain the first graph from the graph database,
wherein the third prompt comprises a third instruction and the first graph, and
wherein the third instruction comprises a procedure for generating the second document from the first graph.

9. An information processing method comprising a first phase, the first phase comprising:
a first step in which a first component receives and transmits a material comprising a first document, including a first element and a second element, and a first diagram, illustrating the first element, the second element, and a relation between the first element and the second element, to a second component comprising a first subcomponent and a second subcomponent comprising a graph database and a management system;
a second step in which the first subcomponent creates a first prompt comprising a first instruction, the first document, and the first diagram and transmits the first prompt to a third component, the first prompt being included in a first prompt chain created and executed by the first subcomponent;
a third step in which the third component generates and transmits an interpretation sentence in accordance with the first instruction comprising a procedure for generating the interpretation sentence from the first diagram in consideration of the first document by using a vision language model to the second component;
a fourth step in which the first subcomponent creates a second prompt included in the first prompt chain and transmits the second prompt comprising a second instruction, the first document, and the interpretation sentence to the third component, the second instruction comprising a procedure for generating a first graph from the first document and the interpretation sentence;
a fifth step in which the third component generates the first graph by using the vision language model and transmits the first graph to the second component;
a sixth step in which the first subcomponent creates a first query sentence comprising a request to register the first graph;
a seventh step in which the management system registers the first graph in the graph database in accordance with the first query sentence; and
an eighth step in which the second component transmits the first graph to the first component,
wherein the interpretation sentence comprises a natural language description of the first element, the second element, and the relation between the first element and the second element, and
wherein the first graph is described in a graph description language.

10. The information processing method according to claim 9,
wherein in the eighth step, the second component transmits the first graph and the interpretation sentence to the first component, and
wherein in a ninth step, the first component receives and provides the first graph and the interpretation sentence.

11. The information processing method according to claim 10, further comprising:
a tenth step following the ninth step in which the first subcomponent creates and transmits a third prompt included in a second prompt chain created and executed by the first subcomponent to the third component, the third prompt comprising a third instruction, comprising a procedure for generating a second diagram from the first graph, and the first graph;
an eleventh step in which the third component generates the second diagram by using the vision language model and transmits the second diagram to the second component;
a twelfth step in which the first subcomponent creates a fourth prompt included in the second prompt chain and transmits the fourth prompt comprises a fourth instruction comprising a procedure for evaluating the second diagram based on the first diagram, the first diagram, and the second diagram to the third component;
a thirteenth step in which the third component generates an evaluation result in accordance with the fourth prompt by using the vision language model and transmits the evaluation result to the second component; and
a fourteenth step in which the second component transmits the second diagram and the evaluation result to the first component.

12. The information processing method according to claim 9, further comprising:
a second phase following the first phase, the second phase comprising:
a fifteenth step in which the first component receives and transmits an idea document to the second component;
a sixteenth step in which the first subcomponent creates and transmits a fifth prompt comprising a fifth instruction, comprises a procedure for generating a second graph from the idea document, and the idea document to the third component;
a seventeenth step in which the third component generates the second graph by using a large language model and transmits the second graph to the second component;
an eighteenth step in which the first subcomponent creates a second query sentence comprising a request to register the second graph; and
a nineteenth step in which the management system registers the second graph in the graph database in accordance with the second query sentence,
wherein the second graph is described in the graph description language.

13. The information processing method according to claim 12, the second phase further comprising:
a twentieth step in which the first component receives a selection command and transmits specifying information comprising information specifying a node of the second graph to the second component;
a twenty-first step in which the first subcomponent creates a third query sentence comprising a request to obtain information relating to a third element stored in the node on the basis of the specifying information;
a twenty-second step in which the management system obtains the information from the graph database in accordance with the third query sentence;
a twenty-third step in which the first subcomponent creates a sixth prompt comprising a sixth instruction and the information and transmits the sixth prompt to the third component, the sixth instruction comprising a procedure for generating a question regarding the information;
a twenty-fourth step in which the third component generates the question by using the large language model and transmits the question to the second component; and
a twenty-fifth step in which the second component receives the question and transmits the question to the first component.

14. The information processing method according to claim 12, the second phase further comprising:
a twentieth step in which the first component receives a selection command and transmits specifying information comprising information specifying an edge of the second graph to the second component;
a twenty-first step in which the first subcomponent creates a third query sentence comprising a request to obtain information relating to a relation between a third element and a fourth element stored in the edge on the basis of the specifying information;
a twenty-second step in which the management system obtains the information from the graph database in accordance with the third query sentence;
a twenty-third step in which the first subcomponent creates a sixth prompt comprising a sixth instruction and the information and transmits the sixth prompt to the third component, the sixth instruction comprising a procedure for generating a question regarding the information;
a twenty-fourth step in which the third component generates the question by using the large language model and transmits the question to the second component; and
a twenty-fifth step in which the second component receives the question and transmits the question to the first component.

15. The information processing method according to claim 9, further comprising:
a second phase following the first phase, the second phase comprising:
a ninth step in which the first component receives a selection command and transmits a parameter comprising information for starting generation of a second document to the second component;
a tenth step in which the first subcomponent creates a second query sentence comprising a request to obtain the first graph from the graph database;
an eleventh step in which the management system obtains the first graph from the graph database in accordance with the second query sentence;
a twelfth step in which the first subcomponent creates a third prompt comprising a third instruction and the first graph and transmits the third prompt to the third component, the third instruction comprising a procedure for generating the second document from the first graph;
a thirteenth step in which the third component generates the second document by using a large language model and transmits the second document to the second component; and
a fourteenth step in which the second component receives the second document and transmits the second document to the first component,
wherein the second document comprises a description relating to the first element, the second element, and the relation between the first element and the second element.
